(19) United States
(12) Patent Application Publication
(10) Pub. No.: US 2026/0094396 A1
(43) Pub. Date: Apr. 2, 2026

(54) SYSTEMS AND METHODS FOR PRESENTING A VIRTUAL REPRESENTATION IN A THREE-DIMENSIONAL ENVIRONMENT

(71) Applicant: Apple Inc., Cupertino, CA (US)

(72) Inventors: Wei WANG, Santa Clara, CA (US); Sean B. KELLY, San Francisco, CA (US); Devin W. CHALMERS, Oakland, CA (US); William D. LINDMEIER, San Francisco, CA (US)

(21) Appl. No.: 19/285,204

(22) Filed: Jul. 30, 2025

Related U.S. Application Data
(60) Provisional application No. 63/700,592, filed on Sep. 27, 2024.

(51) Int. Cl. G06T 19/20; G06F 3/16; H04L 65/1089; H04L 65/403

(52) U.S. Cl. CPC G06T 19/20; G06F 3/167; H04L 65/1089; H04L 65/403; G06T 2219/024; G06T 2219/2016

(57) ABSTRACT

Some examples of the disclosure are directed to systems and methods for presenting virtual representations of participants of a communication session in a three-dimensional environment. In some examples, while a first electronic device presents a representation of a user oriented toward a first target location of a set of target locations associated with the communication session, the first electronic device receives an indication of a change of pose of a second electronic device associated with the user. In some examples, in response to receiving the indication, in accordance with a determination that the change of pose of the second electronic device includes rotation about a first axis that satisfies one or more first criteria, the first electronic device presents the representation of the user oriented toward a second target location, different from the first target location, of the set of target locations.

### CROSS REFERENCE TO RELATED APPLICATIONS

This application claims the benefit of U.S. Provisional Application No. 63/700,592, filed Sep. 27, 2024, the content of which is herein incorporated by reference in its entirety for all purposes.

### FIELD OF THE DISCLOSURE

This relates generally to systems and methods of presenting virtual representations of users in a three-dimensional environment.

### BACKGROUND OF THE DISCLOSURE

Some computer graphical environments provide two-dimensional and/or three-dimensional environments where at least some objects displayed for a user's viewing are virtual and generated by a computer.

### SUMMARY OF THE DISCLOSURE

Some examples of the disclosure are directed to systems and methods for presenting virtual representations of participants of a communication session in a three-dimensional environment. In some examples, while a first electronic device is in a communication session with a second electronic device different from the first electronic device, wherein the first electronic device is associated with a first user and the second electronic device is associated with a second user, the first electronic device presents, via one or more displays, a plurality of virtual objects associated with the communication session in a three-dimensional environment. In some examples, the plurality of virtual objects includes a shared virtual object and a representation of the second user. In some examples, the first electronic device presents the representation of the second user oriented toward a first target location of a set of target locations in the three-dimensional environment. In some examples, the set of target locations corresponds to a representation of the first user and the plurality of virtual objects other than the representation of the second user. In some examples, while the first electronic device presents the representation of the second user oriented toward the first target location, the first electronic device receives an indication of a change of pose of the second electronic device. In some examples, in response to receiving the indication of the change of pose of the second electronic device, in accordance with a determination that the change of pose of the second electronic device includes rotation about a first axis that satisfies one or more first criteria, the first electronic device presents, via the one or more displays, the representation of the second user oriented toward a second target location, different from the first target location, of the set of target locations. In some examples, in response to receiving the indication of the change of pose of the second electronic device, in accordance with a determination that the change of pose of the second electronic device does not include rotation about the first axis that satisfies the one or more first criteria, the first electronic device maintains presentation of the representation of the second user oriented toward the first target location of the set of target locations.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIGS. 2A-2B illustrate block diagrams of example architectures for electronic devices according to some examples of the disclosure.

FIGS. 3A-3L illustrate examples of a first electronic device presenting a virtual representation of a user in a communication session according to some examples of the disclosure.

FIG. 4 is a flow diagram of an example process for presenting a virtual representation of a user in a communication session according to some examples of the disclosure.

### DETAILED DESCRIPTION

Some examples of the disclosure are directed to systems and methods for presenting virtual representations of participants of a communication session in a three-dimensional environment. In some examples, while a first electronic device is in a communication session with a second electronic device different from the first electronic device, wherein the first electronic device is associated with a first user and the second electronic device is associated with a second user, the first electronic device presents, via one or more displays, a plurality of virtual objects associated with the communication session in a three-dimensional environment. In some examples, the plurality of virtual objects includes a shared virtual object and a representation of the second user. In some examples, the first electronic device presents the representation of the second user oriented toward a first target location of a set of target locations in the three-dimensional environment. In some examples, the set of target locations corresponds to a representation of the first user and the plurality of virtual objects other than the representation of the second user. In some examples, while the first electronic device presents the representation of the second user oriented toward the first target location, the first electronic device receives an indication of a change of pose of the second electronic device. In some examples, in response to receiving the indication of the change of pose of the second electronic device, in accordance with a determination that the change of pose of the second electronic device includes rotation about a first axis that satisfies one or more first criteria, the first electronic device presents, via the one or more displays, the representation of the second user oriented toward a second target location, different from the first target location, of the set of target locations. In some examples, in response to receiving the indication of the change of pose of the second electronic device, in accordance with a determination that the change of pose of the second electronic device does not include rotation about the first axis that satisfies the one or more first criteria, the first electronic device maintains presentation of the representation of the second user oriented toward the first target location of the set of target locations.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes).

As used herein, an object that is displayed in a world-locked orientation in a three-dimensional environment does not have a distance or orientation offset defined relative to the user, and instead has a position and orientation defined relative to the three-dimensional environment.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

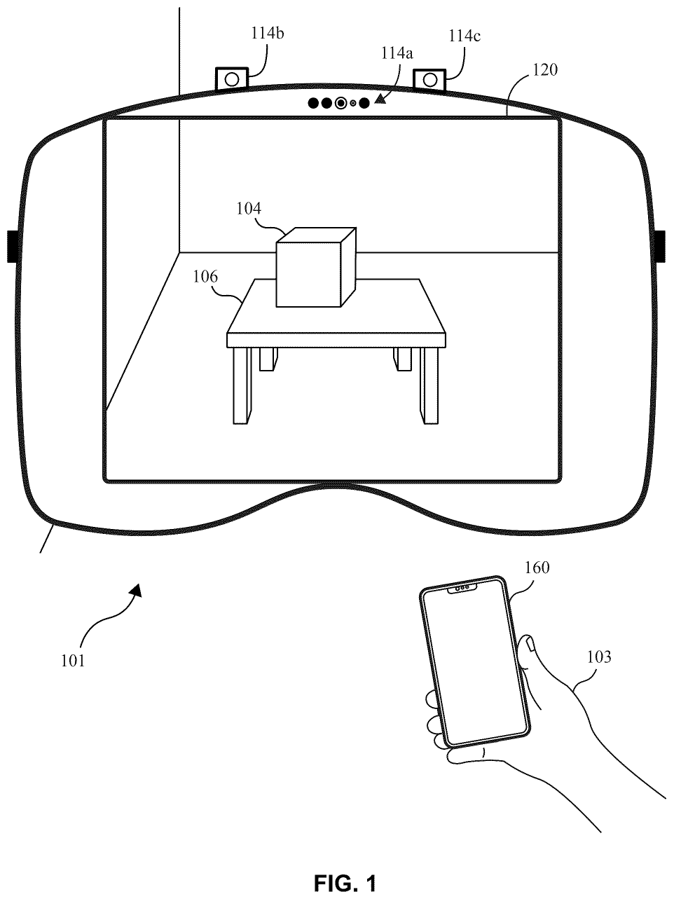

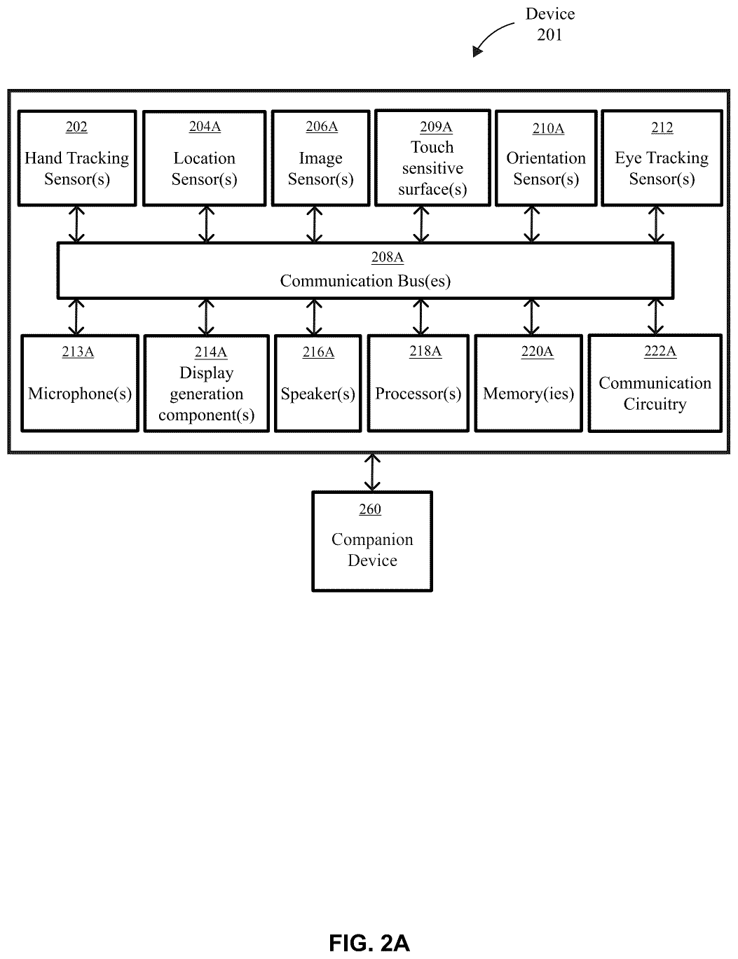

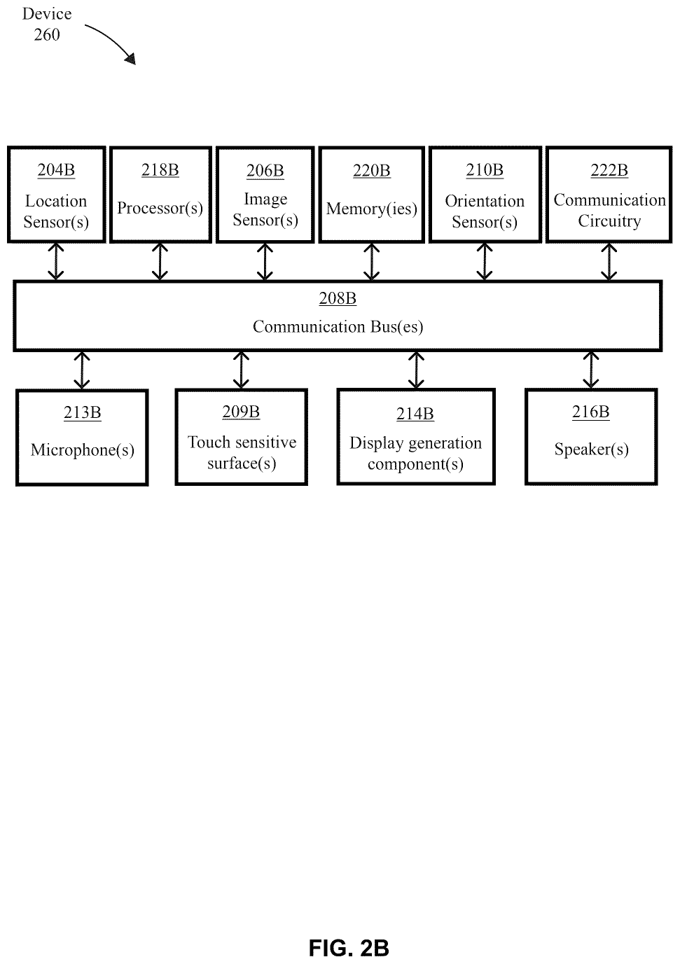

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays. In some examples, display 120 is a passive display that outputs content (e.g., images and/or video) rendered by a second electronic device, such as electronic device 160 described below.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, the electronic device 101 may be configured to communicate with a second electronic device, such as a companion device. For example, as illustrated in FIG. 1, the electronic device 101 may be in communication with electronic device 160. In some examples, the electronic device 160 corresponds to a mobile electronic device, such as a smartphone, a tablet computer, a smart watch, or other electronic device. Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned (e.g., mounted) on a head of a user and the electronic device 160 may be positioned near electronic device 101, such as in a hand 103 of the user (e.g., the hand 103 is holding of the electronic device 160), and the electronic device 101 and the electronic device 160 are associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices 201 and 260 according to some examples of the disclosure. In some examples, electronic device 201 and/or electronic device 260 include one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1. In some examples, electronic device 260 corresponds to electronic device 160 described above with reference to FIG. 1. Electronic device 201 and electronic device 260 optionally form and/or are included in a computing system.

As illustrated in FIG. 2A, the electronic device 201 optionally includes various sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), one or more display generation components 214A, optionally corresponding to display 120 in FIG. 1, one or more speakers 216A, one or more processors 218A, one or more memories 220A, and/or communication circuitry 222A. One or more communication buses 208A are optionally used for communication between the above-mentioned components of electronic devices 201. Additionally, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260. The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

In some examples, processor(s) 218A, 218B include one or more general processors, one or more graphics processors, and/or one or more digital signal processors. In some examples, memory 220A or 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some examples, memory 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214A, 214B include a single display (e.g., a liquid-crystal display (LCD), organic light-emitting diode (OLED), or other types of display). In some examples, display generation component(s) 214A, 214B includes multiple displays. In some examples, display generation component(s) 214A, 214B can include a display with touch capability (e.g., a touch screen), a projector, a holographic projector, a retinal projector, a transparent or translucent display, etc. In some examples, electronic devices 201 and 260 include touch-sensitive surface(s) 209A and 209B, respectively, for receiving user inputs, such as tap inputs and swipe inputs or other gestures. In some examples, display generation component(s) 214A, 214B and touch-sensitive surface(s) 209A, 209B form touch-sensitive display(s) (e.g., a touch screen integrated with each of electronic devices 201 and 260 or external to each of electronic devices 201 and 260 that is in communication with each of electronic devices 201 and 260).

In some examples, electronic device 201 includes one or more controllable tinting layers, where each controllable tinting layer may be configured to filter an adjustable amount of light (e.g., light having a particular wavelength or range of wavelengths). The one or more tinting layers may be used to at least partially block a user's view of the physical environment and enhance a virtual image displayed using an optical see-through display. In some examples, the tinting layers are integrated into display generation component 214A. In some examples, the tinting layers are separate from the display generation component 214A. In some examples, one of the controllable tinting layers may include a frosted glass layer that can be controlled to scatter an adjustable amount of incident light. Alternatively, in some examples, electronic device 201 may not include a separate controllable tinting layer. For example, the tinting functionality may be integrated into display generation component 214A (e.g., integrated in the other layers of display generation component 214A).

Electronic devices 201 and 260 optionally includes image sensor(s) 206A and 206B, respectively. Image sensors(s) 206A, 206B optionally include one or more visible light image sensors, such as charged coupled device (CCD) sensors, and/or complementary metal-oxide-semiconductor (CMOS) sensors operable to obtain images of physical objects from the real-world environment. Image sensor(s) 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A, 206B also optionally include one or more cameras configured to capture movement of physical objects in the real-world environment. Image sensor(s) 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201, 260 uses CCD sensors, event cameras, and depth sensors in combination to detect the physical environment around electronic device 201, 260. In some examples, image sensor(s) 206A, 206B include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201, 260 uses image sensor(s) 206A, 206B to detect the position and orientation of electronic device 201, 260 and/or display generation component(s) 214A, 214B in the real-world environment. For example, electronic device 201, 260 uses image sensor(s) 206A, 206B to track the position and orientation of display generation component(s) 214A, 214B relative to one or more fixed objects in the real-world environment.

In some examples, electronic devices 201 and 260 include microphone(s) 213A and 213B, respectively, or other audio sensors. Electronic device 201, 260 optionally uses microphone(s) 213A, 213B to detect sound from the user and/or the real-world environment of the user. In some examples, microphone(s) 213A, 213B includes an array of microphones (a plurality of microphones) that optionally operate in tandem, such as to identify ambient noise or to locate the source of sound in space of the real-world environment.

In some examples, electronic devices 201 and 260 include location sensor(s) 204A and 204B, respectively, for detecting a location of electronic device 201A and/or display generation component(s) 214A and a location of electronic device 260 and/or display generation component(s) 214B, respectively. For example, location sensor(s) 204A, 204B can include a global positioning system (GPS) receiver that receives data from one or more satellites and allows electronic device 201, 260 to determine the device's absolute position in the physical world.

In some examples, electronic devices 201 and 260 include orientation sensor(s) 210A and 210B, respectively, for detecting orientation and/or movement of electronic device 201 and/or display generation component(s) 214A and orientation and/or movement of electronic device 260 and/or display generation component(s) 214B, respectively. For example, electronic device 201, 260 uses orientation sensor(s) 210A, 210B to track changes in the position and/or orientation of electronic device 201, 260 and/or display generation component(s) 214A, 214B, such as with respect to physical objects in the real-world environment. Orientation sensor(s) 210A, 210B optionally include one or more gyroscopes and/or one or more accelerometers.

In some examples, electronic device 201 includes hand tracking sensor(s) 202 and/or eye tracking sensor(s) 212 (and/or other body tracking sensor(s), such as leg, torso and/or head tracking sensor(s)). Hand tracking sensor(s) 202 are configured to track the position/location of one or more portions of the user's hands, and/or motions of one or more portions of the user's hands with respect to the extended reality environment, relative to the display generation component(s) 214A, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214A. In some examples, hand tracking sensor(s) 202 and/or eye tracking sensor(s) 212 are implemented together with the display generation component(s) 214A. In some examples, the hand tracking sensor(s) 202 and/or eye tracking sensor(s) 212 are implemented separate from the display generation component(s) 214A. In some examples, electronic device 201 alternatively does not include hand tracking sensor(s) 202 and/or eye tracking sensor(s) 212. In some such examples, the display generation component(s) 214A may be utilized by the electronic device 260 to provide an extended reality environment and utilize input and other data gathered via the other sensor(s) (e.g., the one or more location sensors 204A, one or more image sensors 206A, one or more touch-sensitive surfaces 209A, one or more motion and/or orientation sensors 210A, and/or one or more microphones 213A or other audio sensors) of the electronic device 201 as input and data that is processed by the processor(s) 218B of the electronic device 260. Additionally or alternatively, electronic device 201 optionally does not include other components shown in FIG. 2B, such as location sensors 204B, image sensors 206B, touch-sensitive surfaces 209B, etc. In some such examples, the display generation component(s) 214A may be utilized by the electronic device 260 to provide an extended reality environment and the electronic device 260 utilize input and other data gathered via the one or more motion and/or orientation sensors 210A (and/or one or more microphones 213A) of the electronic device 201 as input.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A are positioned relative to the user to define a field of view of the image sensor(s) 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards examples of a first electronic device presenting a virtual representation of a user in a communication session. The first electronic device optionally has one or more characteristics of electronic devices 101 and/or 201 described above. In some examples, the first electronic device is in communication with a first companion device, which optionally has one or more characteristics of electronic devices 160 and/or 260 described above (e.g., the first electronic device and the first companion device are included within a computing system). The first electronic device is optionally in the communication session with a second electronic device. In some examples, the second electronic device has one or more characteristics of electronic devices 101 and/or 201 described above, and is optionally in communication with a second companion device (e.g., having one or more characteristics of electronic devices 160 and/or 260 described above).

In some examples, virtual representations of participants of a communication session, such as avatars and/or virtual personas, may be presented (e.g., spatially) by an electronic device in a three-dimensional environment. In some examples, it may be desirable for one or more spatial characteristics of a virtual representation of a participant, such as a location and/or orientation of one or more portions of the virtual representation in the three-dimensional environment, to be at least partially based on detected characteristics of one or more physical portions of the participant (e.g., a representative head pose of the virtual representation is based on a physical head pose of the participant, or a representative gaze location of the virtual representation is based on a gaze location of the participant). The below described methods and processes enables the first electronic device to virtually represent attention and/or movement of a participant of a communication session in a three-dimensional environment when a second electronic device of the participant includes orientation sensors (e.g., for detecting motion and/or orientation of the second electronic device) but optionally does not include image sensors, location sensors, eye-tracking sensors, and/or hand tracking sensors, which enhances the functionality of the communication session despite the second electronic device not including sensors for tracking physical portions of the participant.

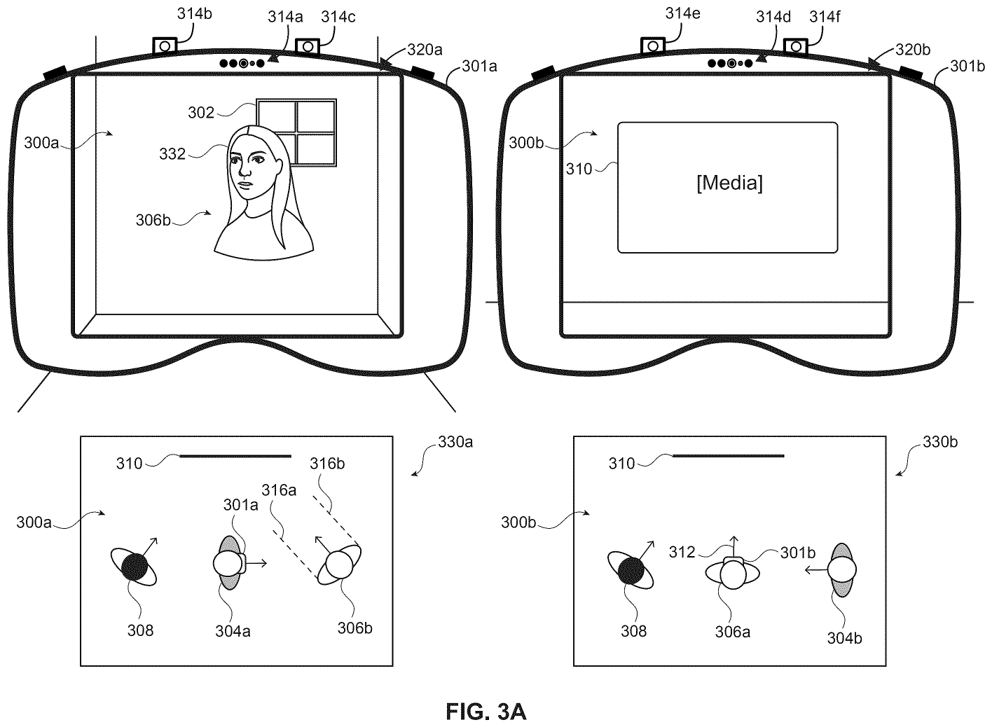

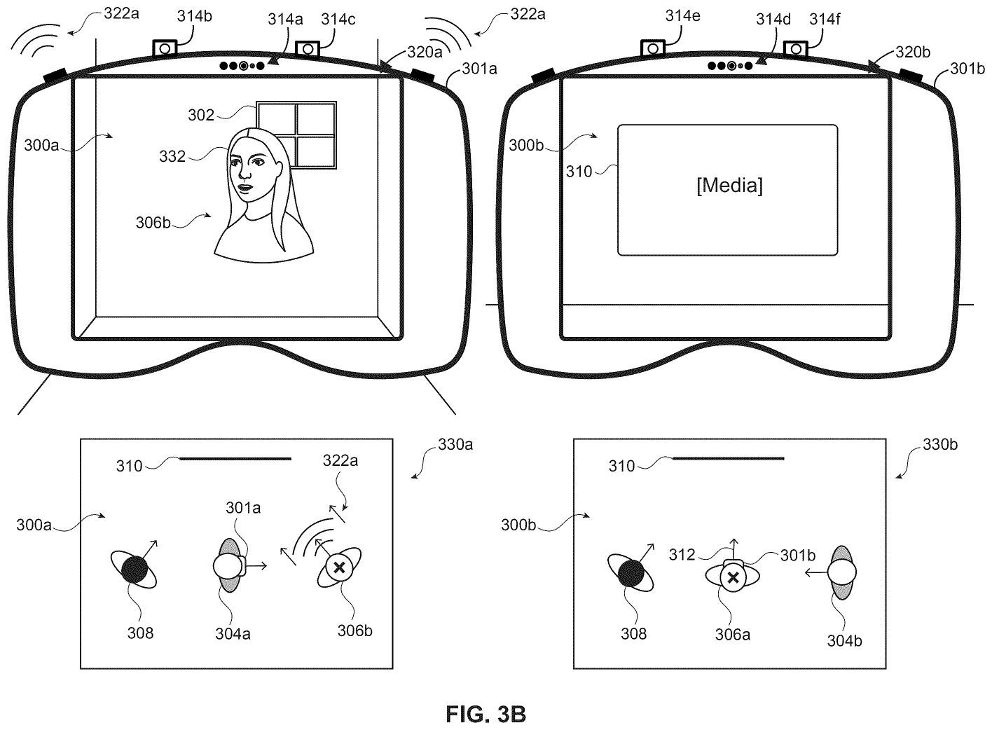

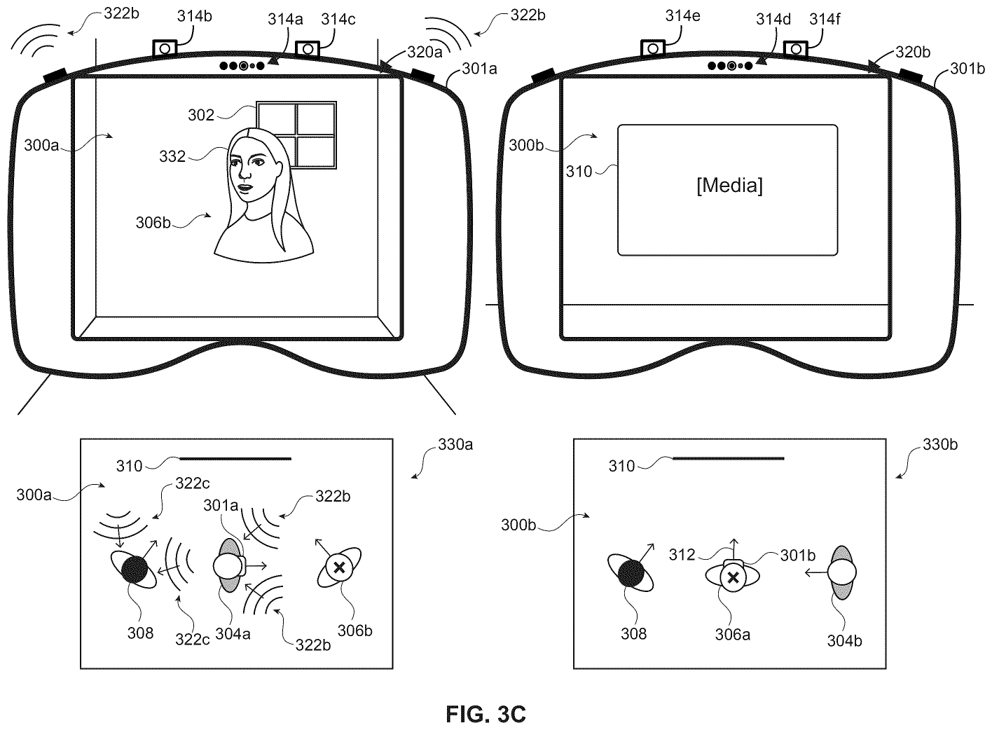

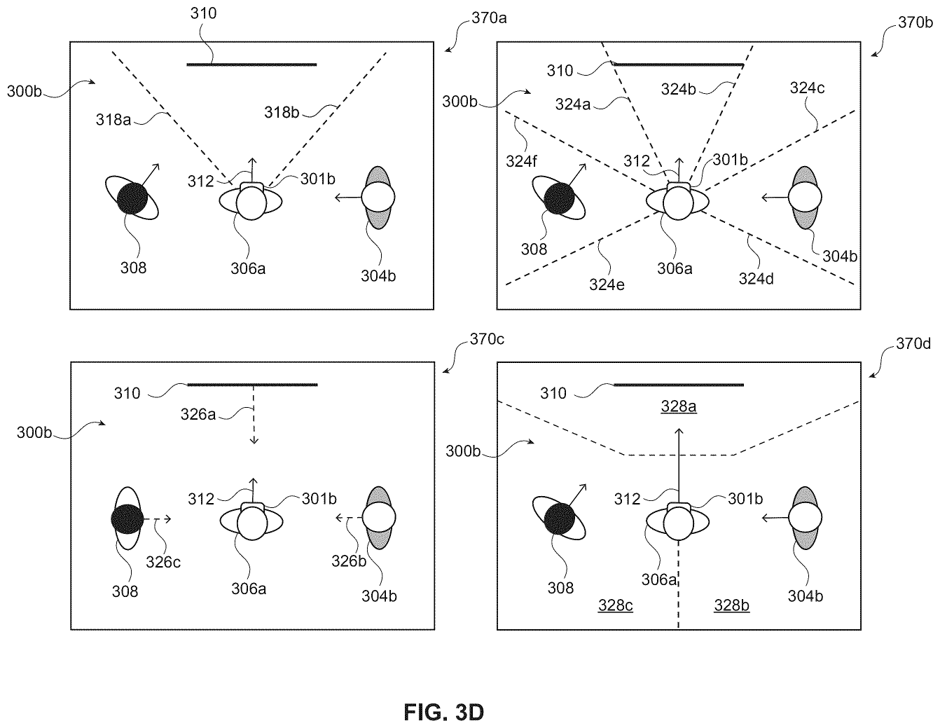

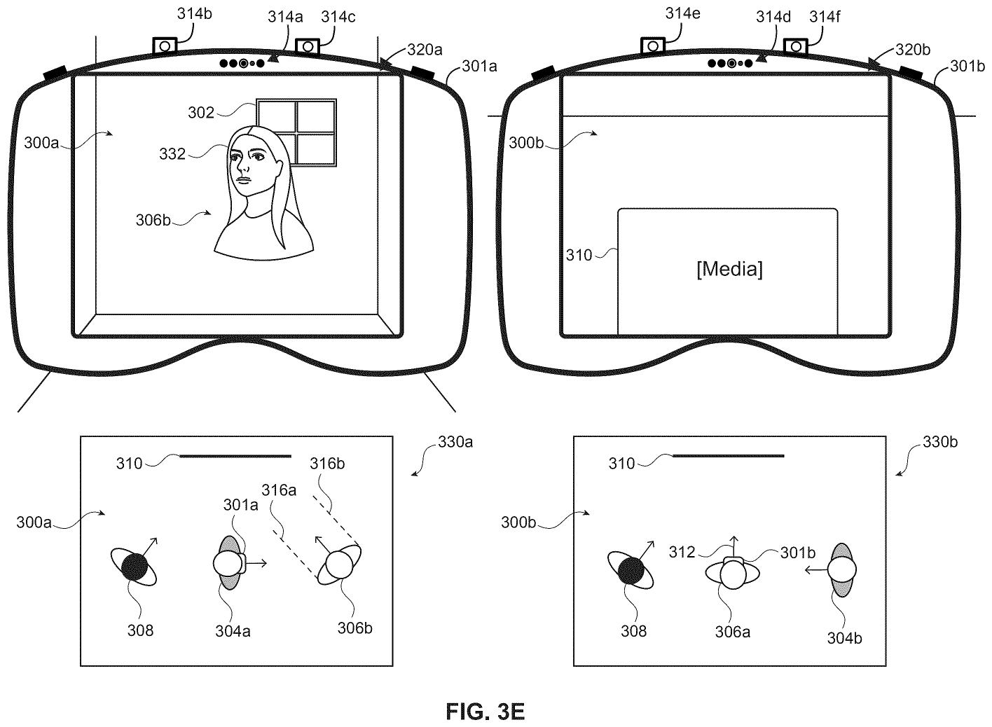

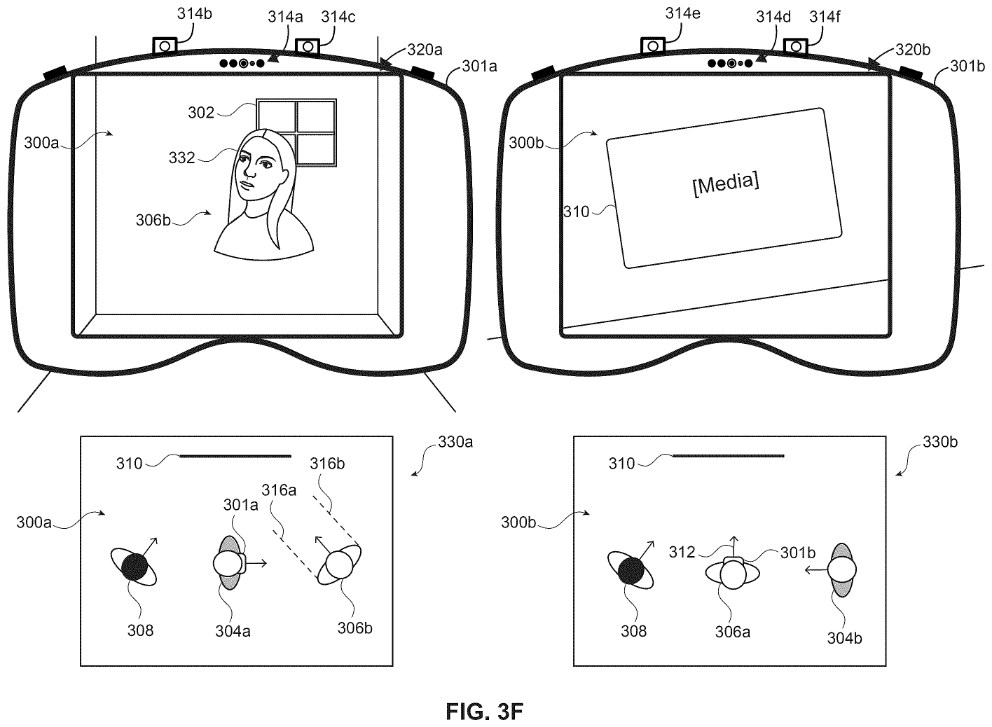

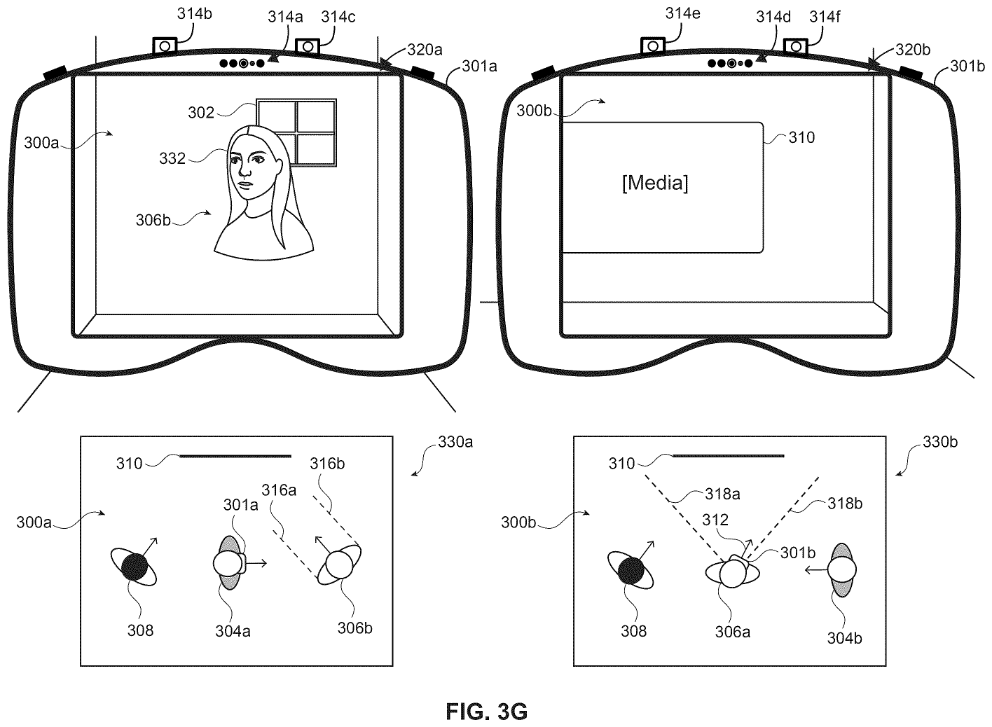

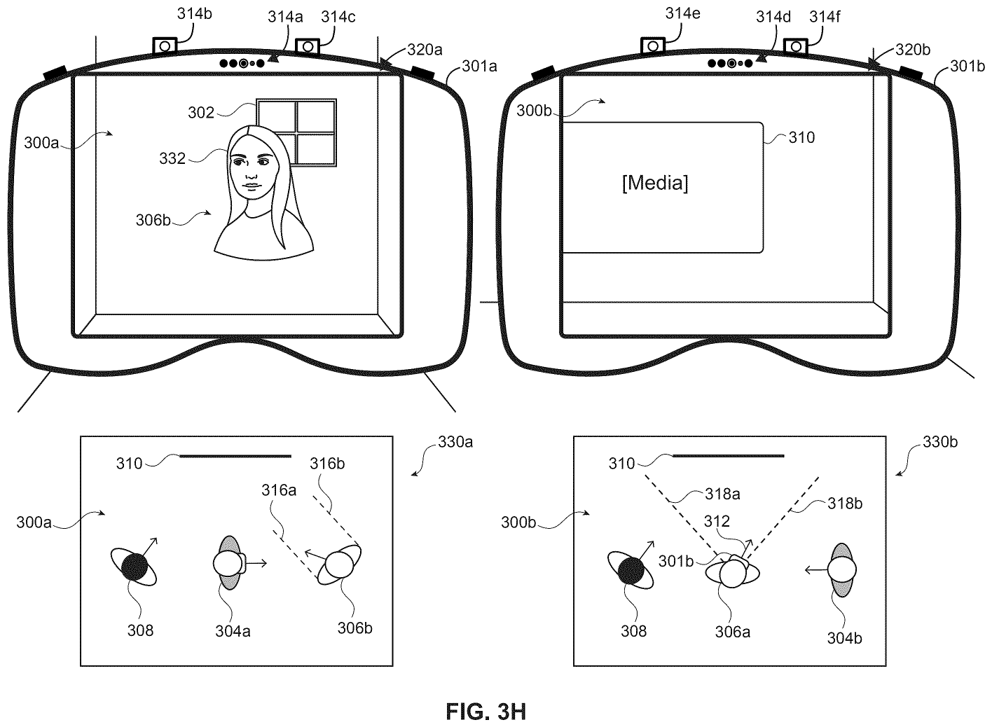

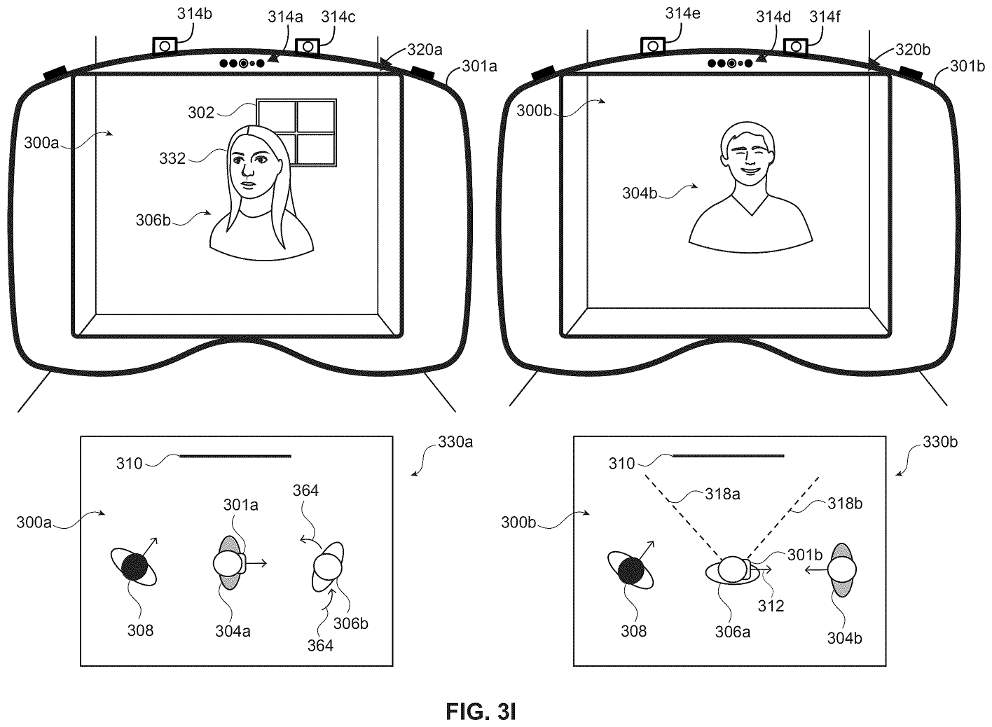

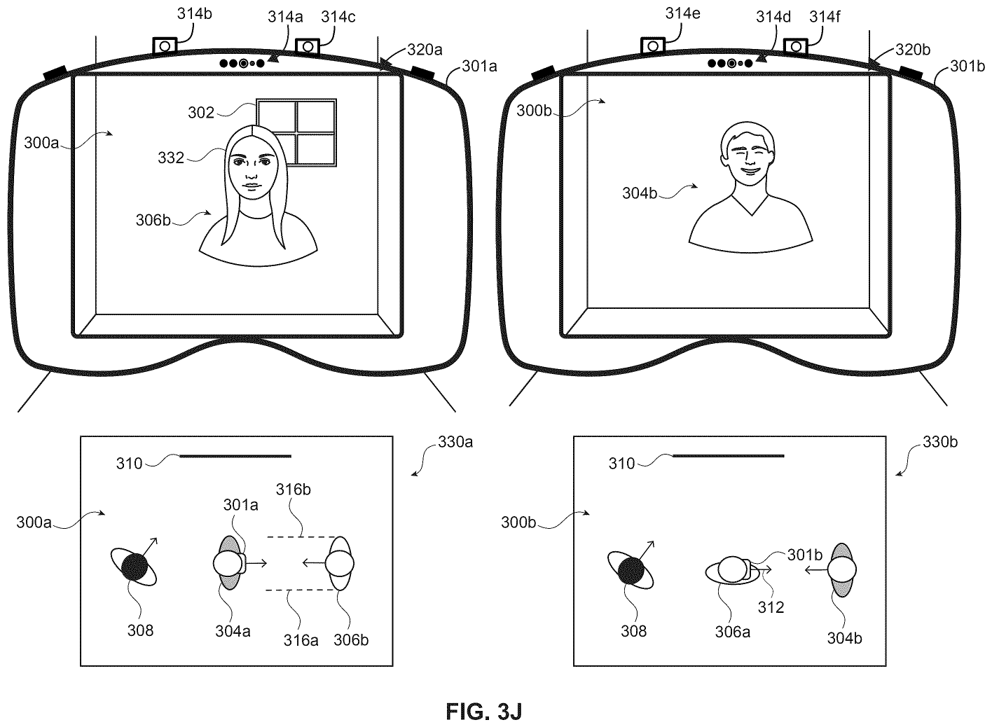

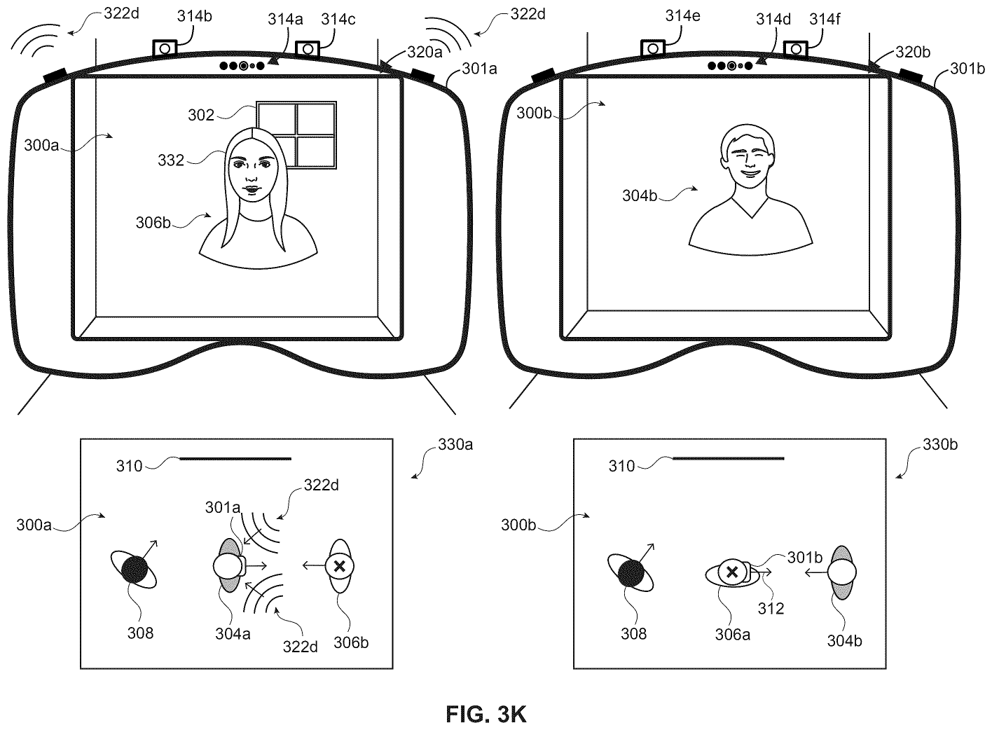

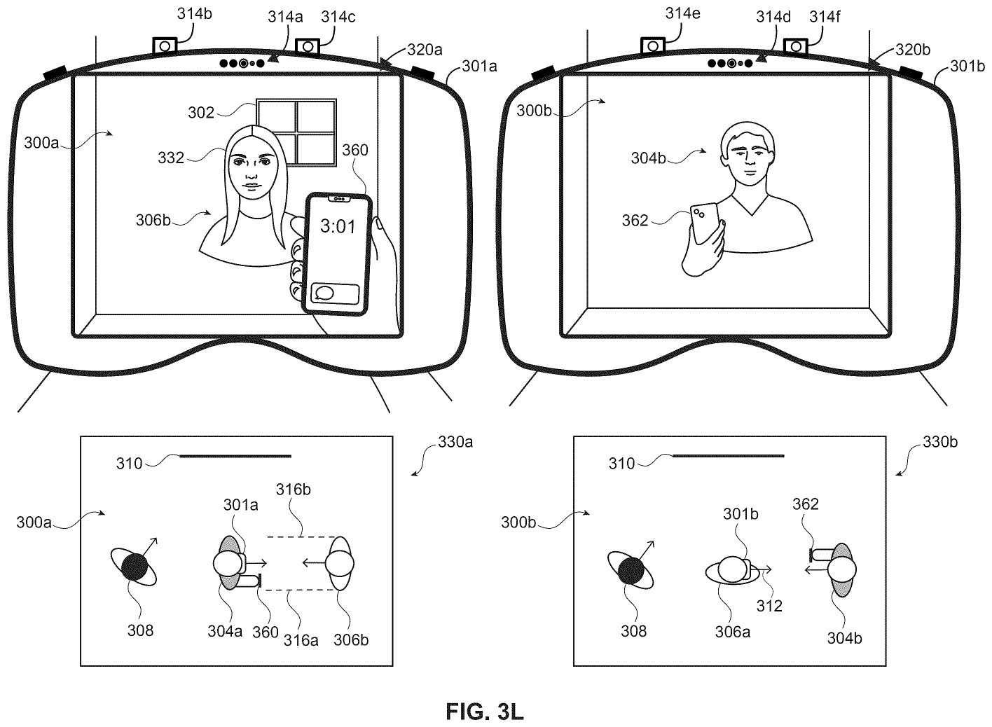

FIGS. 3A-3L illustrate examples of a first electronic device presenting a virtual representation of a user in a communication session according to some examples of the disclosure. For example, the first electronic device 301a is in the communication session with a second electronic device 301b. In some examples, the communication session is a real-time (e.g., or nearly real-time) communication session that includes audio (e.g., real-time voice audio from participants in the communication session and/or audio content associated with shared media) and/or other shared content (e.g., virtual representations (e.g., representations of virtual environments, avatars, and/or virtual personas associated with participants of the communication session), images, applications, and/or interactive media (e.g., video game media)). In some examples, the communication session includes computer-generated video of one or more participants of the communication session (e.g., by changing one or more characteristics of a virtual representation of the participant). The computer-generated video of participants of the communication session is optionally presented through virtual representations of the participants (e.g., avatars and/or virtual personas (e.g., including virtual representations of one or more physical features of the participants)) that are spatially distributed within a three-dimensional environment. In some examples, the communication session is associated with a respective application that is accessible via the first electronic device and/or second electronic device, such as an application for facilitating real-time and/or computer-generated video and/or audio calls (e.g., through the reception and transmission of audio signals).

In some examples, first electronic device 301a and/or second electronic device 301b have one or more characteristics of electronic device 101 and/or 201 described above. As shown in FIGS. 3A-3L, first electronic device 301a includes a display 320a and second electronic device 301b includes a display 320b. Display 320a and/or 320b optionally have one or more characteristics of display 120 and/or display generation component(s) 214A described above. In some examples, display 320a and/or 320b optionally include multiple display generation components (e.g., two stereo displays). Further, as shown in FIGS. 3A-3L, first electronic device 301 includes image sensors 314a to 314c (e.g., having one or more characteristics of image sensors 114a to 114c and/or image sensors(s) 206) and second electronic device includes image sensors 314d to 314f (e.g., having one or more characteristics of image sensors 114a to 114c and/or image sensor(s) 206). In some examples, image sensors 314a to 314f are configured to detect one or more objects of a physical environment (e.g., having one or more characteristics of a real-world environment and/or a physical environment described above). In some examples, image sensors 314a to 314f are configured to detect movement of one or more portions (e.g., hand(s), head, and/or eyes) of a user and/or attention (e.g., gaze) of a user. First electronic device 301a and/or second electronic device 301b optionally do not include image sensors. For example, first electronic device 301a and/or second electronic device 301b are optionally not configured to detect one or more objects of a physical environment and/or one or more portions of a user (e.g., head and/or hand(s)), and/or attention (e.g., gaze (e.g., through eye-tracking)).

First electronic device 301a is optionally in communication with a first companion device (e.g., companion device 360 shown and described with reference to FIG. 3L) and second electronic device 301b is optionally in communication with a second companion device. For example, the first companion device and/or the second companion device have one or more characteristics of electronic device 160 and/or 260 described above. For example, first electronic device 301a and the first companion device form and/or are included in a first computing system, and second electronic device 301b and the second companion device form and/or are included in a second computing system. It should be understood that operations described below (e.g., presenting, moving, orienting, modifying, receiving, detecting, determining, etc.) as being performed by first electronic device 301a are optionally performed at least in part by the first companion device (e.g., the first companion device causes the operations to be performed by first electronic device 301a). For example, first electronic device 301a includes a passive display, and content (e.g., virtual representation 306b) is rendered by the first companion device and sent to first electronic device 301a to present in environment 300a. For example, the first companion device renders the content in response to receiving an indication (e.g., a wireless signal) from one or more electronic devices of the communication session (e.g., second electronic device 301b and/or the second companion device), such as an indication of a change of pose of second electronic device 301b as described below. It should also be understood that operations described below (e.g., presenting, moving, orienting, modifying, receiving, detecting, determining, etc.) as being performed by second electronic device 301b are optionally performed at least in part by the second companion device (e.g., the second companion device causes the operation to be performed by second electronic device 301b). For example, second electronic device 301b includes a passive display, and content (e.g., shared virtual object 310) is rendered by the second companion device and sent to second electronic device 301b to present in environment 300b. For example, the second companion device renders the content in response to receiving an indication from one or more electronic devices of the communication session (e.g., first electronic device 301a and/or the first companion device), such as the indication of user interaction with companion device 360 described with reference to FIG. 3L.

In FIGS. 3A-3L, an environment 300a is visible via display 320a, and an environment 300b is visible via display 320b. In some examples, environment 300a is a three-dimensional environment that is presented to a first user 304a (shown in top-down view 330a) of first electronic device 301a via display 320a, and environment 300b is a three-dimensional environment that is presented to a second user 306a (shown in top-down view 330b) of second electronic device 301b via display 320b. In some examples, environment 300a and/or 300b are extended reality (XR) environments having one or more characteristics of an XR environment described above. For example, from a current viewpoint of first user 304a of first electronic device 301a, one or more virtual objects (e.g., virtual representation 306b of second user 306a) are presented by first electronic device 301a in environment 300a while one or more physical objects (e.g., real-world window 302) from a physical environment of first user 304a are visible (e.g., through video passthrough and/or optical see-through of the physical environment). For example, from a current viewpoint of second user 306a of second electronic device 301b, one or more virtual objects (e.g., shared virtual object 310) are presented by second electronic device 301b in environment 300b while one or more physical objects from a physical environment of second user 306a are visible (e.g., through video passthrough and/or optical see-through of the physical environment). For example, first user 304a views (e.g., from a first perspective) the communication session (e.g., and/or one or more virtual objects associated with the communication session, such as virtual representation 306b and/or shared virtual object 310) in environment 300a, and second user 306a views (e.g., from a second perspective) the communication session in environment 300b. First user 304a (and/or first electronic device 301a) and second user 306a (and/or second electronic device 301b) are optionally not located in the same physical space (e.g., first user 304a and second user 306a are not within the same room).

In some examples, environments 300a and 300b include one or more virtual objects that are associated with the communication session. FIGS. 3A-3L include a top-down view 330a of environment 300a and a top-down view 330b of environment 300b that include an example set of virtual objects associated with the communication session. For example, the communication session includes a shared virtual object 310, which is optionally a virtual window including shared media (e.g., image, video, and/or audio content (e.g., associated with a video streaming application that is viewed in the communication session)). Additionally, or alternatively, the communication session includes one or more shared virtual objects different from shared virtual object 310, such as virtual windows including user interfaces of web-browsing, messaging, and/or social media applications, and/or representative virtual objects (e.g., three-dimensional virtual representations of physical objects). In some examples, as shown in top-down views 330a and 330b, the set of virtual objects associated with the communication session includes virtual representations of participants of the communication session. For example, environment 300a includes a virtual representation 306b of second user 306a and a virtual representation 308 of a third user (e.g., of a third electronic device in the communication session, the third electronic device optionally having one or more characteristics of first electronic device 301a and/or second electronic device 301b (e.g., the third electronic device includes a third companion device having one or more characteristics of the first companion device and/or the second companion device)).

The communication session optionally provides a shared virtual space for participants to interact with and/or view shared virtual content, such as shared virtual object 310 (e.g., the shared virtual space is viewed within environment 300a from the perspective of first user 304a and within environment 300b from the perspective of second user 306a). Spatial relationships within the shared virtual space between participants and/or shared virtual objects are optionally different from the perspective of each participant. For example, in environment 300a, first user 304a is arranged relative to a center of shared virtual object 310 and between virtual representation 306b of second user 306a and virtual representation 308 of the third user, while in environment 300b, second user 306a is arranged relative to the center of shared virtual object 310 and between virtual representation 304b of first user 304a and virtual representation 308 of the third user (e.g., such that the spatial relationship between first user 304a and virtual representation 306b of second user 306a in environment 300a is inverted compared to the spatial relationship between second user 306a and virtual representation 304b of first user 304a in environment 300b). Additionally, or alternatively, the participants of the communication session are optionally arranged in predetermined locations within the shared virtual space. For example, the predetermined locations may be set relative to shared virtual content, such as the location of the participants (e.g., first user 304a and/or virtual representations 306b and 308 in environment 300a, and second user 306a and/or virtual representations 304b and 308 in environment 300b) relative to shared virtual object 310 shown in top-down views 330a and 330b in FIGS. 3A-3L. It should be understood that the shared virtual space of the communication session is optionally not completely virtual and/or immersive (e.g., as shown in FIGS. 3A-3L, users 304a and 306a view the virtual objects associated with the communication session (e.g., shared virtual object 310 and/or virtual representations 304b, 306b, and 308) while video passthrough and/or optical see-through of the physical environments of users 304a and 306a are also visible, via displays 320a and 320b, in environments 300a and 300b).

In some examples, in the communication session, a participant may move one or more virtual objects associated with the communication session, such as shared virtual object 310 and/or virtual representations 304b and/or 306b, within the shared virtual space (e.g., through a user input that includes an air gesture (e.g., detected by one or more image sensors of an electronic device and/or a companion device) or a touch gesture provided on a touch-sensitive surface of a companion device having one or more characteristics of electronic device 160 and/or 260 described above). The movement of shared virtual content relative to a first participant of the communication session optionally does not move the shared virtual content relative to a second participant of the communication session. For example, in response to detecting a user input provided by second user 306a corresponding to a request to move shared virtual object 310 in environment 300b, second electronic device 301b moves (e.g., and/or the second companion device causes movement of) shared virtual object 310 in environment 300b from the perspective of second user 306a while first electronic device 301a does not move shared virtual object 310 in environment 300a from the perspective of first user 304a.

In some examples, presenting one or more virtual representations of participants in the shared virtual space of the communication session includes orienting the one or more virtual representations toward one or more target locations of a set of target locations. The set of target locations optionally correspond to the virtual objects associated with the communication session. For example, in the communication session shown in FIGS. 3A-3L, the set of target locations correspond to shared virtual object 310, virtual representations 304b, virtual representation 306b, and virtual representation 308. Establishing a set of target locations in the communication session for orienting a virtual representation of a participant of the communication session toward enables attention of the participant to be virtually represented in the communication session when an electronic device of the participant includes orientation sensors (e.g., for detecting motion and/or orientation of the electronic device) and optionally does not include image, location, eye-tracking, and/or hand-tracking sensors (e.g., for detecting attention (e.g., gaze) and/or one or more physical portions of the user), which enhances the user experience of participants in the communication session (e.g., by indicating to a first participant where attention of a second participant is directed to in the communication session).

FIG. 3A illustrates first electronic device 301a presenting to first user 304a, via display 320a, virtual representation 306b of second user 306a oriented toward shared virtual object 310 in environment 300a (e.g., the orientation of virtual representation 306b in environment 300a is represented by reference lines 316a and 316b in top-down view 330a). For example, as shown in top-down view 330a, first user 304a is wearing first electronic device 301a (e.g., first electronic device 301a is a head-mounted display), and a current viewpoint of first user 304a in environment 300a is such that virtual representation 306b is within the current field of view of first user 304a (and/or first electronic device 301a). In some examples, shared virtual object 310 corresponds to a first target location in environment 300a of the set of target locations for orienting virtual representations, such as virtual representation 306b, toward. The first target location is optionally a default and/or initial target location that virtual representation 306b is oriented toward (e.g., from the perspective of first user 306a and/or the third user represented by virtual representation 308) when second user 306a enters the communication session.

In some examples, virtual representation 306b is oriented toward shared virtual object 310 in environment 300a in accordance with an indication received by first electronic device 301a (and/or the first companion device). In some examples, the indication is received from second electronic device 301b (and/or the second companion device). The indication is optionally a signal received through a network such as a personal, local, or wide area network, and/or from one or more servers in communication with first electronic device 301a (and/or in communication with a first companion device that is in communication with first electronic device 301a). For example, the indication is transmitted by a second companion device in communication with second electronic device 301b to a first companion device in communication with first electronic device 301a (e.g., through a server that is in communication with the first companion device and the second companion device). For example, the first companion device in communication with first electronic device 301a renders virtual representation 306b and/or sends a signal to first electronic device 301a to present virtual representation 306b oriented toward shared virtual object 310 in accordance with the received indication.

In some examples, the indication includes information associated with a current pose of second electronic device 301b. In some examples, in accordance with a determination that a current pose of second electronic device 301b corresponds to shared virtual object 310 (e.g., a forward vector corresponding to the current viewpoint of second user 306a and/or second electronic device 301b in environment 300b is directed toward shared virtual object 310), first electronic device 301a presents virtual representation 306b oriented toward shared virtual object 310 in environment 300a. For example, as shown in FIG. 3A, a forward vector 312 of the current pose of second electronic device 301b (e.g., from a perspective and/or current viewpoint of second user 306a) corresponds to (e.g., is directed toward) shared virtual object 310 in environment 300b. For example, as shown in FIG. 3A, in accordance with the current pose (e.g., the forward vector 312 of the current pose) of second electronic device 301b corresponding to shared virtual object 310, second electronic device 301b presents to second user 306a, via display 320b, shared virtual object 310 in environment 300b and first electronic device 301a presents to first user 304a, via display 320a, virtual representation 306b of second user 306a oriented toward shared virtual object 310 in environment 300a. In some examples, the determination that the current pose of second electronic device 301b corresponds to shared virtual object 310 is performed by first electronic device 301a (and/or the first companion device) using the information included in the indication. Alternatively, in some examples, the determination that the current pose of second electronic device 301b corresponds to shared virtual object 310 is performed by second electronic device 301b (and/or the second companion device), and the indication received by first electronic device 301a (and/or the first companion device) includes information corresponding to the first target location (e.g., the indication includes an instruction to present virtual representation 306b oriented toward shared virtual object 310). The determination that the current pose corresponds to shared virtual object 310 optionally has one or more characteristics of the determinations described below with reference to FIG. 3D.

In some examples, a virtual representation of a participant of the communication session includes one or more portions corresponding to representations of one or more physical portions of a person (e.g., representations of a head, face, eyes, and/or torso of a person). For example, as shown in FIG. 3A, virtual representation 306b includes a first portion 332. For example, first portion 332 corresponds to a representative head pose of second user 306a (e.g., first portion 332 is a virtual representation of a head of second user 306a). In some examples, a pose of first portion 332 is updated in environment 300a (e.g., relative to a current target location virtual representation 306b is oriented toward) based on changes in head pose of second user 306 (and/or changes in pose of second electronic device 301b optionally detected by one or more orientation sensors of second electronic device 301b) (e.g., as shown and described with reference to FIGS. 3D-3H). Virtual representation 306b optionally represents one or more physical characteristics of second user 306a (e.g., virtual representation 306b is created and/or generated by second electronic device 301b (and/or by the second companion device) using one or more images captured of second user 306a (e.g., virtual representation 306b was created prior to second user 306a entering the communication session).

In some examples, the virtual objects associated with the communication session are optionally presented by first electronic device 301a and/or second electronic device 301b as body-locked objects. For example, in FIG. 3A, first electronic device 301a presents virtual representation 306b in a body-locked orientation in environment 300a (e.g., having one or more characteristics of presenting a three-dimensional object in a body-locked orientation as described above). For example, in response to rotational movement of first user 304a and/or first electronic device 301a (e.g., pitch, roll, and/or yaw rotation of first electronic device 301a), first electronic device 301a maintains presentation of virtual representation 306b (e.g., and/or the first companion device causes presentation of virtual representation 306b to be maintained) at the same location and/or orientation in environment 300a (e.g., such that an offset distance is maintained in environment 300a between virtual representation 306b and a portion (e.g., a torso) of first user 304a). For example, in response to translational movement of first user 304a and/or first electronic device 301a relative to environment 300a, first electronic device 301a moves (e.g., and/or the first companion device causes movement) of virtual representation 306b in environment 300a (e.g., such that an offset distance is maintained between virtual representation 306b and a portion (e.g., a torso) of first user 304a). Further, for example, in FIG. 3A, second electronic device 301b presents shared virtual object 310 in a body-locked orientation in environment 300. For example, in response to rotational movement of second user 306a and/or second electronic device 301b (e.g., pitch, roll, and/or yaw rotation of second electronic device 301b), second electronic device 301b maintains presentation of shared virtual object 310 (e.g., and/or the second companion causes presentation of shared virtual object 310 to be maintained) at the same location and/or orientation in environment 300b (e.g., such that an offset distance is maintained in environment 300b between virtual representation 304b and a portion (e.g., a torso) of second user 306a). For example, in response to translational movement of second user 306a and/or second electronic device 301b relative to environment 300b, second electronic device 301b moves (e.g., and/or the second companion device causes movement of) shared virtual object 310 in environment 300b (e.g., such that an offset distance is maintained between shared virtual object 310 and a portion (e.g., a torso) of second user 306a).

FIG. 3B illustrates first electronic device 301a outputting audio 322a in accordance with an indication of participation of second user 306a in the communication session (e.g., the participation of second user 306a is indicated by an “X” shown on virtual representation 306b in top-down view 330a and second user 306a in top-down view 330b). In some examples, the indication is received by first electronic device 301a and/or the first companion device. For example, the indication received by first electronic device 301a and/or the first companion device in FIG. 3B has one or more characteristics of the indication described above with reference to FIG. 3A. In some examples, the indication includes an audio signal associated with an audio input (e.g., corresponding to second user 306a speaking in the communication session) that is detected by one or more input devices (e.g., microphones 213A and/or 213B described above) of second electronic device 301b and/or the second companion device. For example, in accordance with the received indication, first electronic device 301a (and/or the first companion device) transmits and/or transduces the audio signal such that it is audible to first user 304a. In some examples, audio 322a is output through an audio output device of first electronic device 301a, and/or an audio output device in communication with first electronic device 301a and optionally worn by first user 304a, such as a set of speakers (e.g., speaker(s) 216A described above), headphones, or earbuds.

In some examples, as shown in FIG. 3B, audio 322a is output to first user 304a spatially based on an orientation of virtual representation 306b of second user 306a in environment 300a. For example, as shown in top-down view 330a, audio 322a is output to simulate emanation from a location of virtual representation 306b and optionally in a direction toward shared virtual object 310. For example, from the perspective of first user 304a, audio 322a is output by the audio output device to simulate emanation of audio 322a from a location in environment 300a in front of first user 301a. In some examples, at a third electronic device of the third user represented by virtual representation 308 (e.g., the third electronic device is in communication with first electronic device 301a and second electronic device 301b in the communication session), audio corresponding to the participation of second user 306a in the communication session is output spatially based on a spatial relationship of the third user to virtual representation 306b (e.g., in a three-dimensional environment presented by the third electronic device). In some examples, the participation of second user 306a is output to first user 304a and the third user because the current pose (e.g., the forward vector 312 of the current pose) of second electronic device 301b is directed toward shared virtual object 310. In some examples, in accordance with a determination that second user 306a participates in the communication session while the current pose (e.g., the forward vector 312 of the current pose) of second electronic device 301b corresponds to a virtual representation of a respective participant (e.g., virtual representation 304b or virtual representation 308), the audio is optionally output to the respective participant without being output to other participants in the communication session (e.g., as shown and described with reference to FIG. 3K).

In some examples, in accordance with the indication received in FIG. 3B, first electronic device 301a modifies one or more features of virtual representation 306b to represent second user 306a speaking in the communication session. For example, in FIG. 3B, a virtual facial expression (e.g., mouth position) of virtual representation 306b is modified compared to the facial expression of virtual representation 306b shown in FIG. 3A (e.g., prior to the indication corresponding to participation of second user 306a in the communication session). A companion device in communication with first electronic device 301a (e.g., the first companion device described above) optionally receives the indication and renders an updated appearance of virtual representation 306b and/or animation of virtual representation 306b (e.g., based on an audio signal included in the received indication), which is transmitted to first electronic device 301a and presented via display 320a.

FIG. 3C illustrates an alternative example of first electronic device 301a outputting audio 322b in accordance with the indication of participation of second user 306a in the communication session (e.g., described with reference to FIG. 3B). For example, the audio signal included in the indication is optionally not output by the audio output device of first electronic device 301a (and/or in communication with first electronic device 301a) spatially based on the spatial relationship between first user 304a and virtual representation 306b in environment 300a. For example, as shown in top-down view 330a, audio 322b does not correspond spatially to the location of virtual representation 306b in environment 300a (e.g., the audio output device optionally does not provide output audio 322b with a spatial effect (e.g., audio 322b is output with an equal volume to a left and right ear of first user 304a)).

In some examples, in accordance with a determination that virtual representation 306b of second user 306a is oriented toward a current target location that does not correspond to a participant and/or a virtual representation of a participant (e.g., the current target location of virtual representation 306b corresponds to shared virtual object 310), audio corresponding to the participation of second user 306a in the communication session is output in a first manner in the communication session. For example, outputting the participation of second user 306a in the first manner in the communication session includes outputting audio associated with the participation of second user 306a in the communication session to all participants of the communication session. For example, in FIG. 3C, a representation of audio 322c is illustrated in top-down view 330a relative to virtual representation 308 of the third user of the communication session, which schematically represents the third user receiving an audio output, via one or more audio output devices of (and/or in communication with) the third electronic device, corresponding to the participation of second user 306a in the communication session. Audio 322c optionally has one or more characteristics of audio 322b described above. It should be understood that audio 322c is shown in top-down view 330a to schematically illustrate audio that is output to the third user via one or more audio output devices of and/or in communication with the third electronic device (which is not shown in the figures), and audio 322c optionally does not represent audio that is output to first user 304a via one or more audio output devices of and/or in communication with first electronic device 301a.

FIG. 3D illustrates example top-down views 370a to 370d of environment 300b. In some examples, in accordance with a determination that a change of pose of second electronic device 301b includes rotation about a first axis of second electronic device 301b that satisfies one or more first criteria, first electronic device 301a presents (and/or the first companion device causes presentation of) virtual representation 306b oriented toward a different target location in the communication session (e.g., a target location different from shared virtual object 310, such as first user 306a). The first axis is optionally a yaw axis (e.g., a Y-axis) of second electronic device 301b (e.g., the rotation about the first axis includes yaw rotation of second electronic device 301b). In some examples, in FIG. 3D, top-down views 370a to 370d include schematic representations of the one or more first criteria for determining when to orient virtual representation 306b of second user 306 to a different target location in response to a change of pose of second electronic device 301b that includes rotation about the first axis (e.g., in accordance with a determination that the one or more first criteria are satisfied, first electronic device 301a updates the current target location of virtual representation 306b (e.g., by modifying the orientation of virtual representation 306b to be directed toward a different target location)).

In some examples, in response to detecting a change of pose of second electronic device 301b (e.g., via one or more orientation sensors of second electronic device 301b), second electronic device 301b and/or the second companion device transmits an indication to first electronic device 301a and/or the first companion device. For example, in response to receiving the indication, first electronic device 301a and/or the first companion device determine whether the change in pose of second electronic device 301b includes rotation about the first axis (e.g., yaw rotation) that satisfies the one or more first criteria (e.g., using one or more of the criteria described with reference to top-down views 370a to 370d). For example, in accordance with a determination that the change of pose of second electronic device 301b includes rotation about the first axis that satisfies the one or more first criteria, first electronic device 301a updates (and/or the first companion device causes the update of) the presentation of virtual representation 306b in environment 300a to be oriented toward a different target location. Alternatively, in some examples, in response to detecting a change of pose of second electronic device 301b (e.g., via one or more orientation sensors of second electronic device 301b), second electronic device 301b and/or the second companion device determine whether the change of pose of second electronic device 301b includes rotation about the first axis (e.g., yaw rotation) that satisfies the one or more first criteria (e.g., using one or more of the criteria described with reference to top-down views 370a to 370d). For example, in accordance with a determination that the change of pose of second electronic device 301b includes rotation about the first axis that satisfies the one or more first criteria, second electronic device 301b and/or the second companion device transmits an indication to first electronic device 301b and/or the first companion device (e.g., the indication includes information associated with the change of pose of second electronic device 301b and/or instructions for orienting virtual representation 306b toward a different target location of the set of target locations). For example, in response to receiving the indication, first electronic device 301a updates (and/or the first companion device causes the update of) the presentation of virtual representation 306b in environment 300a to be oriented toward a different target location.

In some examples, top-down view 370a includes a schematic representation of an example first criterion used (e.g., by first electronic device 301a and/or the first companion device, or by second electronic device 301b and/or the second companion device) to determine which target location of the set of target locations to orient virtual representation 306b toward in response to a change of pose of second electronic device 301b. In some examples, the first criterion is satisfied when the rotation of second electronic device 301b about the first axis exceeds a threshold amount of rotation about the first axis (e.g., a threshold amount of yaw rotation). For example, top-down view 370a includes representations of orientation thresholds 318a and 318b (e.g., schematically representing a threshold amount of rotation about the first axis). For example, in accordance with a determination that the current pose (e.g., forward vector 312 of the current pose) of second electronic device 301b exceeds orientation threshold 318a or 318b (e.g., by rotating by more than a threshold amount about the first axis), first electronic device 301a presents virtual representation 306b oriented toward a different target location. For example, if the forward vector 312 of the current pose of second electronic device 301b exceeds orientation threshold 318a, first electronic device 301a presents virtual representation 306b oriented away from first user 304a (e.g., when virtual representation 308 is the current target location of virtual representation 306b, virtual representation 306b is presented oriented away from the current viewpoint of first user 304a). For example, if the forward vector 312 of the current pose of second electronic device 301b exceeds orientation threshold 318b, first electronic device 301a presents virtual representation 306b oriented toward first user 304a (e.g., first user 304a (and/or virtual representation 304b) is set as the current target location of virtual representation 306b in the communication session from the perspective of the participants of the communication session). In some examples, satisfaction of the first criterion further requires that the current pose (e.g., forward vector 312 of the current pose) of second electronic device 301b exceeds the threshold amount of rotation (e.g., to exceed orientation threshold 318a or 318b) for at least a threshold amount of time (e.g., 0.1, 0.2, 0.5, 1, 2, 5, or 10 seconds). In some examples, the threshold amount of rotation about the first axis optionally corresponds to a length of shared virtual object 310 and optionally a margin (e.g., an additional 1, 2, 5, 10, 15, or 30 degrees of rotation from shared virtual object 310). Additionally, or alternatively, in some examples, orientation thresholds 318a and/or 318b (e.g., the threshold amount of rotation) are fixed relative to a current location of shared virtual object 310 in environment 300b. For example, in accordance with a determination that shared virtual object 310 is moved in environment 300b (e.g., in response to user input provided by second user 306a) such that the forward vector 312 of the current pose of second electronic device 301b exceeds the threshold orientation (e.g., represented by orientation threshold line 318 and/or 318b) from the new location of shared virtual object 310, first electronic device 301a presents virtual representation 306b oriented toward a different target location in environment 300a (e.g., second electronic device 301b and/or the second companion device transmit an indication to first electronic device 301a and/or the first companion device in accordance with a determination that movement of shared virtual object 310 in environment 300b causes a current pose (e.g., forward vector 312 of the current pose) of second electronic device 301b to be greater than the orientation threshold away from shared virtual object 310).

In some examples, top-down view 370b includes a schematic representation of an example second criterion used to determine which target location of the set of target locations to orient virtual representation 306b toward in response to a change of pose of second electronic device 301b. In some examples, satisfaction of the second criterion may vary based on whether a respective target location corresponds to a shared virtual object or a virtual representation of a participant. For example, the second criterion is satisfied when a current target location is not shared virtual object 310 and a change of pose of second electronic device 301b causes forward vector 312 of second electronic device 301b to correspond to shared virtual object 310 (e.g., for at least a threshold amount of time (e.g., 0.1, 0.2, 0.5, 1, 2, 5, or 10 seconds)). For example, the second criterion is satisfied when a current target location is not virtual representation 304b or 308, and a change of pose of second electronic device 301b causes forward vector 312 of second electronic device 301b to be within a threshold orientation of virtual representation 304b or 308 (e.g., for at least a threshold amount of time (e.g., 0.1, 0.2, 0.5, 1, 2, 5, or 10 seconds)). As shown in FIG. 7D, top-down view 370b includes orientation thresholds 324a to 324f. For example, orientation thresholds 324a and 324b schematically represent a threshold amount of rotation relative to shared virtual object 310 (e.g., the threshold amount of rotation corresponds to the length of shared virtual object 310). For example, orientation thresholds 324c and 324d schematically represent a threshold amount of rotation relative to virtual representation 304b of first user 304a (e.g., the threshold amount of rotation corresponds to a width of virtual representation 304b plus a margin (e.g., an additional 1, 2, 5, 10, 15, or 30 degrees of rotation from virtual representation 304b)). For example, orientation thresholds 324e and 324f schematically represent a threshold amount of rotation relative to the third user and/or virtual representation 308 (e.g., the threshold amount of rotation corresponds to a width of virtual representation 308 plus a margin (e.g., an additional 1, 2, 5, 10, 15, or 30 degrees of rotation from virtual representation 308)). In some examples, in accordance with a determination that the current pose (e.g., forward vector 312 of the current pose) of second electronic device 301b does not correspond to shared virtual object 310 and is not within a threshold orientation of virtual representation 304b or 308, first electronic device 301b maintains virtual representation 306b oriented toward its current target location in environment 300a. For example, if the current target location of virtual representation 306b is shared virtual object 310 and the forward vector 312 of the current pose of second electronic device 301b is between orientation threshold 324b and orientation threshold 324c (e.g., forward vector 312 is not within the threshold orientation of virtual representation 304b), first electronic device 301a maintains virtual representation 306b oriented toward shared virtual object 310 in environment 300a (e.g., but optionally changes a pose of first portion 332 of virtual representation 306b relative to shared virtual object 310, as shown in FIG. 3H).

In some examples, top-down view 370c includes a schematic representation of an example third criterion used to determine which target location of the set of target locations to orient virtual representation 306b toward in response to a change of pose of second electronic device 301b. In some examples, the third criterion is satisfied when a change of pose of second electronic device 301b causes forward vector 312 of the current pose of second electronic device 301b to be closer (e.g., relative to orientation) to a different target location than its current target location (e.g., for at least a threshold amount of time (e.g., 0.1, 0.2, 0.5, 1, 2, 5, or 10 seconds)). For example, in accordance with a determination that forward vector 312 is closer to virtual representation 304b than shared virtual object 310, first electronic device 301b presents virtual representation 306b oriented toward first user 304a in environment 300a. Alternatively, or additionally, in some examples, the third criterion is satisfied when a change of pose of second electronic device 301b causes a difference between forward vector 312 and a vector associated with the current target location of virtual representation 306b to be greater than the difference between forward vector 312 and a vector associated with a different target location of the set of target locations. For example, as shown in top-down view 370c, shared virtual object 310 includes a forward vector 326a, virtual representation 304b includes a forward vector 326b, and virtual representation 308 includes a forward vector 326c. For example, if a current target location of virtual representation 306b is shared virtual object 310 and change of pose of second electronic device 301b causes there to be greater difference between (e.g., a greater scalar and/or vector product) between forward vector 312 and forward vector 326a than a difference (e.g., a scalar and/or vector product) between forward vector 312 and forward vector 326b, first electronic device 301b updates the presentation of virtual representation 306b to be oriented toward first user 304a in environment 300a (e.g., and/or the third electronic device updates the presentation of virtual representation 306b to be oriented toward virtual representation 304b from the perspective of the third user).

In some examples, top-down view 370d includes a schematic representation of an example fourth criterion used to determine which target location of the set of target locations to orient virtual representation 306b toward in response to a change of pose of second electronic device 301b. In some examples, the fourth criterion is satisfied when a change of pose of second electronic device 301b causes the current pose (e.g., the forward vector 312 of the current pose) of second electronic device 301b to change from corresponding to a first region of environment 300b to corresponding to a second region of environment 300b (e.g., and the forward vector 312 corresponds to the second region for at least a threshold amount of time (e.g., 0.1, 0.2, 0.5, 1, 2, 5, or 10 seconds)). For example, as shown in top-down view 370d, environment 300b is divided into regions 328a, 328b, and 328c. For example, region 328a of environment 300b corresponds to shared virtual object 310 (e.g., a first target location of the set of target locations), region 328b corresponds to virtual representation 304b and/or first user 304a (e.g., a second target location of the set of target locations), and region 328c corresponds to virtual representation 308 and/or the third user (e.g., a third target location of the set of target locations). For example, if a current target location of virtual representation 306b is shared virtual object 310 and a change of pose of second electronic device 301b causes forward vector 312 to change from corresponding to region 328a to corresponding to region 328b, first electronic device 301a updates the presentation of virtual representation 306b to be oriented toward first user 304a in environment 300a. In some examples, regions 328a to 328c of environment 300b correspond to Voronoi cells. For example, region 328a includes a plurality of locations in environment 300b at which shared virtual object 310 is the closest target location of the set of target locations, region 328b includes a plurality of locations in environment 300b at which virtual representation 304b and/or first user 304a is the closest target location of the set of target locations, and region 328c includes a plurality of locations in environment 300b at which virtual representation 308 and/or the third user is the closest target location of the set of target locations. In some examples, second electronic device 301b and/or the second companion device update regions 328a to 328c of environment 300b when one or more virtual objects associated with the communication session are moved in environment 300b. For example, in accordance with a determination that shared virtual object 310 is moved in environment 300b (e.g., in response to user input provided by second user 306a), second electronic device 301b and/or the second companion device divide environment 300b into new regions based on the new location of shared virtual object 310 (e.g., new Voronoi cells are defined within environment 300b corresponding to the current locations of shared virtual object 310, virtual representation 304b, and virtual representation 308).

It should be understood that the one or more first criteria for determining when to orient virtual representation 306b of second user 306 to a different target location may include one or more of the criteria shown and described with reference to top-down views 370a to 370d in FIG. 3D.

In some examples, in accordance with a determination that a change of pose of second electronic device 301b does not include rotation about the first axis (and/or includes rotation about the first axis that does not satisfy the one or more first criteria), first electronic device 301a maintains presentation of virtual representation 306b oriented toward shared virtual object 310. Additionally, or alternatively, in some examples, first electronic device 301a changes a pose of first portion 332 of virtual representation 306b relative to shared virtual object 310 (e.g., instead of orienting virtual representation 306b toward a different target location) in accordance with a determination that the change of pose of second electronic device 301b satisfies one or more second criteria. For example, the one or more second criteria are satisfied when the change of pose of second electronic device 301b includes rotation about a second axis and/or a third axis, different from the first axis (e.g., pitch and/or roll rotation instead of yaw rotation), as shown and described with reference to FIGS. 3E and 3F. Additionally, or alternatively, for example, the one or more second criteria are satisfied when the change of pose of second electronic device 301b includes rotation about the first axis (e.g., yaw rotation) that does not satisfy the one or more first criteria, as shown and described with reference to FIG. 3H.

FIG. 3E illustrates first electronic device 301a presenting first portion 332 of virtual representation 306b with a different pose (e.g., compared to FIGS. 3A-3C) relative to shared virtual object 310 in environment 300a in accordance with an indication of a change of pose of second electronic device 301b that includes rotation about a second axis (e.g., a pitch axis (e.g., X-axis)) of second electronic device 301b. As shown in FIG. 3E, second user 306a rotates their head (and/or second electronic device 301b) upward relative to shared virtual object 310 in environment 300b. For example, as shown in FIG. 3E, second electronic device 301b presents, via display 320b, an updated view of environment 300b in response to the change of pose of second electronic device 301b (e.g., to correspond to an updated field of view of second user 306a). In some examples, in FIG. 3E, first electronic device 301a maintains presentation of virtual representation 306b oriented toward shared virtual object 310 in environment 300a because the change of pose of second electronic device 301b does not include rotation about the first axis of second electronic device 301b (e.g., does not include yaw rotation). In some examples, in accordance with a determination (e.g., made by first electronic device 301a, the first companion device, second electronic device 301b, and/or the second companion device) that the change of pose includes rotation about the second axis, optionally different from the first axis (e.g., pitch rotation instead of yaw rotation), first electronic device 301a changes a pose (e.g., and/or the first companion device causes a change of pose) of first portion 332 relative to shared virtual object 310 (e.g., to virtually represent pitch rotation of second electronic device 301b and/or the head of second user 306a).

FIG. 3F illustrates first electronic device 301a presenting first portion 332 of virtual representation 306b with a different pose (e.g., compared to FIGS. 3A-3C) relative to shared virtual object 310 in accordance with an indication of a change of pose of second electronic device 301b that includes rotation about a third axis (e.g., a roll axis (e.g., Z-axis)) of second electronic device 301b. As shown in FIG. 3F, second user 306a tilts (e.g., rotates about a roll axis) their head (and/or second electronic device 301b) rightward relative to shared virtual object 310 in environment 300b. For example, as shown in FIG. 3F, second electronic device 301b presents, via display 320b, an updated view of environment 300b in response to the change of pose of second electronic device 301b (e.g., to correspond to an updated field of view of second user 306a). In some examples, in FIG. 3F, first electronic device 301a maintains presentation of virtual representation 306b oriented toward shared virtual object 310 in environment 300a because the change of pose of second electronic device 301b does not include rotation about the first axis of second electronic device 301b (e.g., does not include yaw rotation). In some examples, in accordance with a determination (e.g., made by first electronic device 301a, the first companion device, second electronic device 301b, and/or the second companion device) that the change of pose of second electronic device 301b includes rotation about the third axis, optionally different from the first axis (e.g., roll rotation instead of yaw rotation), first electronic device 301a changes a pose (e.g., and/or the first companion device causes a change of pose) of first portion 332 relative to shared virtual object 310 (e.g., to virtually represent roll rotation of second electronic device 301b and/or the head of second user 306a). The change of pose of first portion 332 of virtual representation 306b presented in environment 300a is optionally inverted compared to the change of pose of second electronic device 301b (e.g., because the spatial arrangement between first user 304a and virtual representation 306b in environment 300a is inverted compared to the spatial arrangement between second user 306a and virtual representation 304b in environment 300b).

FIG. 3G illustrates first electronic device 301a maintaining presentation of first portion 332 of virtual representation 306b with the same pose (e.g., compared to FIGS. 3A-3C) relative to shared virtual object 310 in accordance with an indication of a change of pose of second electronic device 301b that includes rotation about the first axis (e.g., a yaw axis (e.g., Y-axis)) of second electronic device 301b. As shown in FIG. 3G, second user 306a rotates (e.g., about a yaw axis) their head (and/or second electronic device 301b) rightward relative to share virtual object 310 in environment 300b. For example, as shown in FIG. 3G, second electronic device 301b presents, via display 320b, an updated view of environment 300b in response to the change of pose of second electronic device 301b (e.g., to correspond to an updated field of view of second user 306a). In some examples, in FIG. 3G, first electronic device 301a maintains presentation of virtual representation 306b oriented toward shared virtual object 310 because the change of pose of second electronic device 301b includes rotation about the first axis (e.g., yaw rotation) that does not satisfy the one or more first criteria (e.g., having one or more of the criteria described with reference to FIG. 3D). For example, as shown in top-down view 330b, the one or more first criteria include the first criterion that is satisfied when the rotation of second electronic device 301b about the first axis exceeds a threshold amount of rotation about the first axis, as described above with reference to FIG. 3D (e.g., top-down view 330b shown in FIG. 3G corresponds to top-down view 370a shown in FIG. 3D). For example, as shown in FIG. 3G, the change of pose of second electronic device 301b includes less than a threshold amount of rotation about the first axis (e.g., forward vector 312 of the current pose of second electronic device 301b remains within orientation thresholds 318a and 318b). Additionally, or alternatively, the one or more first criteria include the second, third, and/or fourth criterion described above with reference to FIG. 3D, which are optionally not satisfied by the change of pose of second electronic device 301b in FIG. 3G. In some examples, first electronic device 301a does not present a change of pose of first portion 332 of virtual representation 306b in environment 300 in response to rotation of second electronic device 301b about the first axis that does not satisfy the one or more first criteria. For example, as shown in FIG. 3G, first electronic device 301b does not update the pose of first portion 332 of virtual representation 306b relative to shared virtual object 310 in response to the rotation of second electronic device 301b about the first axis.

FIG. 3H illustrates an alternative example to FIG. 3G that includes first electronic device 301a presenting first portion 332 of virtual representation 306b with a different pose (e.g., compared to FIGS. 3A-3C) relative to shared virtual object 310 in accordance with the indication of the change of pose of second electronic device 301b that includes rotation about the first axis of second electronic device 301b that does not satisfy the one or more first criteria. In some examples, first electronic device 301a presents a change of pose of first portion 332 of virtual representation 306b in environment 300 in response to rotation of second electronic device 301b about the first axis that does not satisfy the one or more first criteria. For example, as shown in FIG. 3H, first electronic device 301b updates the pose (e.g., to represent yaw rotation) of first portion 332 of virtual representation 306b relative to shared virtual object 310 in response to the rotation of second electronic device 301b about the first axis. The change of pose of first portion 332 of virtual representation 306b presented in environment 300a is optionally inverted compared to the change of pose of second electronic device 301b (e.g., because the spatial arrangement between first user 304a and virtual representation 306b in environment 300a is inverted compared to the spatial arrangement between second user 306a and virtual representation 304b in environment 300b).

In some examples, in accordance with a determination that a change of pose of second electronic device 301b includes rotation about multiple axes of second electronic device 301b (and the change of pose does not include rotation about the first axis that satisfies the one or more first criteria), first electronic device 301a presents a change of pose (and/or the first companion device causes presentation of a change of pose) of first portion 332 of virtual representation 306b representing head motion about the multiple axes (e.g., in accordance with a determination that the change of pose of second electronic device 301b includes pitch and yaw rotation, the change of pose of first portion 332 includes representative pitch and yaw rotation (e.g., relative to the current target location of virtual representation 306b)). Additionally, or alternatively, in some examples, in accordance with a determination that a change of pose of second electronic device 301b includes rotation about the first axis and a different axis (e.g., the second axis and/or third axis) of second electronic device 301b (and the rotation about the first axis does not satisfy the one or more first criteria), first electronic device 301a presents a change of pose (e.g., and/or the first companion device causes presentation of a change of pose) of first portion 332 of virtual representation 306b representing head motion about a single axis (e.g., about the second and/or third axis and not the first axis) (e.g., in accordance with a determination that the change of pose of second electronic device 301b includes pitch and yaw rotation, the change of pose of first portion 332 includes representative pitch rotation but does not include representative yaw rotation relative to the current target location of virtual representation 306b).

FIG. 3I illustrates first electronic device 301a transitioning from presenting virtual representation 306b of second user 306a oriented toward shared virtual object 310 (e.g., a first target location of the set of target locations) to presenting virtual representation 306b oriented toward first user 304a (e.g., a second target location of the set of target locations). As shown in FIG. 3I, second user 306a rotates (e.g., about a yaw axis) their head (and/or second electronic device 301b) rightward such that virtual representation 304b of first user 304a is within the current field of view of second user 306a. For example, as shown in FIG. 3I, second electronic device 301b presents, via display 320b, an updated view of environment 300b in response to the change of pose of second electronic device 301b (e.g., to correspond to an updated field of view of second user 306a). In some examples, as shown in top-down view 330b, the rotation of second electronic device 301b about the first axis exceeds the threshold amount of rotation about the first axis (e.g., forward vector 312 exceeds orientation threshold 318b). For example, forward vector 312 of the current pose of second electronic device 301b exceeds a threshold amount of change of orientation, and optionally exceeds the orientation threshold for at least a threshold amount of time (e.g., 0.1, 0.2, 0.5, 1, 2, 5, or 10 seconds).

In some examples, in accordance with a determination that the rotation of second electronic device 301b about the first axis satisfies the one or more first criteria (e.g., as shown in FIG. 3I), first electronic device 301a updates the presentation of virtual representation 306b to be oriented toward first user 304a (e.g., toward a current viewpoint of first user 304a). In some examples, from the perspective of the third user represented by virtual representation 308, a third electronic device of the third user updates the presentation of virtual representation 306b to be oriented toward virtual representation 304b in a three-dimensional environment visible via one or more displays of the third electronic device. In some examples, updating the presentation of virtual representation 306b to be oriented toward first user 304a and/or virtual representation 304b includes presenting an animation. The animation optionally corresponds to a transition from orienting virtual representation 306b toward shared virtual object 310 to orienting virtual representation toward first user 304a and/or virtual representation 304b. In some examples, the animation includes rotation and/or movement of virtual representation 306b (schematically represented by arrows 364 in top-down view 330a and shown by the difference in orientation of virtual representation 306b in FIG. 3I compared to the orientation of virtual representation 306b in FIG. 3A). In some examples, the animation includes modifying one or more visual characteristics of virtual representation 306b (e.g., changing a color, brightness, opacity, and/or sharpness of virtual representation 306b). In some examples, the animation includes increasing the transparency (e.g., gradually until virtual representation 306b is not visible (e.g., over 0.1, 0.2, 0.5, 1, 2, 5, or 10 seconds)) and then decreasing the transparency of virtual representation 306b (e.g., first electronic device 301a fades out the presentation of virtual representation 306b (e.g., while virtual representation 306b is oriented toward shared virtual object 310) and then fades in the presentation of virtual representation 306b (e.g., virtual representation 306b is faded in oriented toward first user 304a)). In some examples, the animation includes replacing virtual representation 306b with a different type of virtual representation during the change of orientation. For example, while virtual representation 306b is presented as oriented toward shared virtual object 310, first electronic device 301a ceases to present virtual representation 306b and presents a virtual representation of a shape (e.g., a coin, circle, square, triangle, etc. (e.g., optionally with a name plate and/or visual indication identifying a name associated with second user 306a)). For example, after moving the virtual representation of the shape to be oriented toward first user 304a, first electronic device 301a ceases to present the virtual representation of the shape in environment 300a and presents virtual representation 306b oriented toward first user 304a in environment 300a.

FIG. 3J illustrates first electronic device 301a presenting virtual representation 306b of second user 306a oriented toward first user 304a. For example, FIG. 3J illustrates the end of the animation shown and described with reference to FIG. 3I. For example, in FIG. 3J, first electronic device 301a has completed moving virtual representation 306b in environment 300a from being oriented toward shared virtual object 310 to being oriented toward first user 304a in accordance with the change of pose of second electronic device 301b that included rotation about the first axis that satisfied the one or more first criteria. As shown in top-down view 330a, the orientation of virtual representation 306b (represented by reference lines 316a) is updated to be oriented toward first user 304a. In some examples, from a perspective of the third user represented by virtual representation 308, the third electronic device of the third user updates the orientation of virtual representation 306b of second user 306a to be oriented toward virtual representation 304b of first user 304a (e.g., in a three-dimensional environment visible to the third user via one or more displays of the third electronic device).

FIG. 3K illustrates first electronic device 301a outputting audio 322d in accordance with an indication corresponding to participation of second user 306a in the communication session (e.g., having one or more characteristics of the indication of participation of second user 306a in the communication session described with reference to FIGS. 3B and 3C). In some examples, audio 322d has one or more characteristics of audio 322b shown and described with reference to FIG. 3C. In some examples, in accordance with a determination that virtual representation 306b of second user 306a is oriented toward a current target location that corresponds to a participant and/or a virtual representation of the participant (e.g., the current target location is first user 304a (e.g., from a perspective of first user 304a) and/or virtual representation 304b of first user 304a (e.g., from a perspective of the third user)), audio corresponding to the participation of second user 306a in the communication session is output in a second manner in the communication session (different from the first manner described above with reference to FIG. 3C). For example, outputting the participation of second user 306a in the communication session in the second manner in the communication session includes only outputting audio corresponding to the participation of second user 306a to the participant associated with the current target location of virtual representation 306b (e.g., and not to all participants of the communication session).

For example, in FIG. 3K, in accordance with virtual representation 306b having first user 304a as its current target location, audio corresponding to the participation of second user 306a (e.g., audio 322d) is output, via one or more audio output devices of and/or in communication with first electronic device 301a, to first user 304 without being output, via one or more audio output devices of and/or or in communication with the third electronic device, to the third user (e.g., top-down view 330a in FIG. 3K does not include representative audio relative to virtual representation 308 of the third user, such as audio 322c shown in top-down view 330a in FIG. 3C). For example, the third electronic device (and/or a third companion device) receives an indication corresponding to the participation of second user 306a in the communication and forgoes outputting audio associated with the participation of second user 306a (e.g., because the current target location of virtual representation 306b of second user 306a is first user 304a and/or virtual representation 304b of first user 304a). Alternatively, for example, in response to detecting the participation of second user 306a in the communication session, second electronic device 301b and/or the second companion device transmit an indication of the participation to first electronic device 301a and/or the first companion device and forgo transmitting an indication of the participation to the third electronic device (and/or a third companion device in communication with the third electronic device) (e.g., because the current target location of virtual representation 306b of second user 306a is first user 304a and/or virtual representation 304b of first user 304a).

FIG. 3L illustrates second electronic device 301b presenting a representation in environment 300b corresponding to first user 304a interacting with a companion device 360. In some examples, companion device 360 has one or more characteristics of the first companion device, electronic device 160, and/or electronic device 260 described above. As shown in FIG. 3L, first user 304a picks up companion device 360 (e.g., with their hand). In some examples, in FIG. 3L, companion device 360 detects, via one or more input devices (e.g., image sensor(s) 206B and/or orientation sensor(s) 210B, and/or touch sensitive surface(s) 209B), first user 304a interacting with companion device 360. In some examples, in response to detecting the interaction of first user 304a with companion device 360, companion device 360 sends an indication to second electronic device 301b (and/or the second companion device) to modify the presentation virtual representation 304b of first user 304a in environment 300b to represent first user 304a interacting with companion device 360. For example, as shown in FIG. 3L, second electronic device 301b presents (e.g., and/or the second companion device causes presentation of) virtual representation 304b with a representation 362 of companion device 360. In some examples, second electronic device 301b optionally changes a facial expression and/or a pose of one or more portions of virtual representation 304b (e.g., a representation of a head of virtual representation 304b) when presenting the representation of first user 304a interacting with companion device 360. For example, while first user 304a interacts with companion device 360, companion device 360 tracks one or more portions (e.g., a head and/or face) of first user 304a using one or more image sensors (e.g., image sensor(s) 206B). For example, the indication received by second electronic device 301b (and/or the second companion device) from companion device 360 includes information associated with a current head pose and/or facial expression of first user 304a. For example, second electronic device 301b presents (e.g., and/or the second companion device causes second electronic device 301b to present) virtual representation 304b with a representative face expression or representative head pose to correspond to the current head pose and/or facial expression of first user 304a.

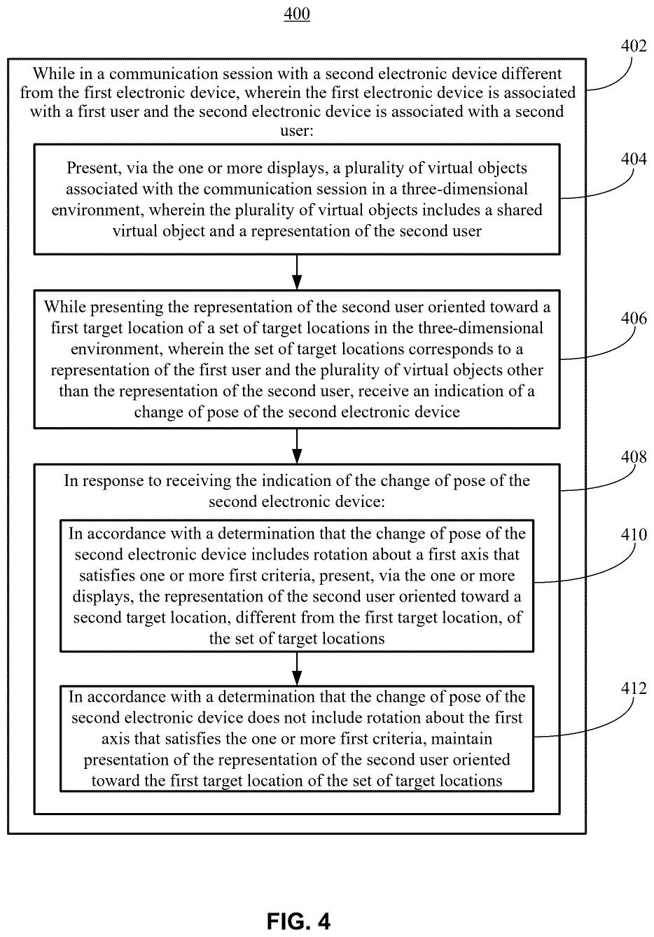

FIG. 4 illustrates a flow diagram of an example process for presenting a virtual representation of a user in a communication session according to some examples of the disclosure. In some examples, process 400 begins at a first electronic device in communication with one or more displays and one or more input devices. In some examples, the first electronic device is optionally a head-mounted display similar or corresponding to electronic device 201 of FIG. 2A. The first electronic device is optionally in communication with a companion device similar or corresponding to electronic device 260 of FIG. 2B.

In some examples, at 402, while in a communication session with a second electronic device different from the first electronic device, wherein the first electronic device is associated with a first user and the second electronic device is associated with a second user, the first electronic device presents, at 404, via the one or more displays, a plurality of virtual objects associated with the communication session in a three-dimensional environment, wherein the plurality of virtual objects includes a shared virtual object and a representation of the second user. In some examples, the communication session has one or more characteristics of the communication session described with reference to FIGS. 3A-3J. In some examples, second electronic device has one or more characteristics of the first electronic device. In some examples, the first electronic device corresponds to first electronic device 301a of FIGS. 3A-3J, and the second electronic device corresponds to second electronic device 301b of FIGS. 3A-3J. In some examples, as shown in FIG. 3A, environment 300a includes shared virtual object 310 and a virtual representation 306b of second user 306a.

In some examples, while presenting the representation of the second user oriented toward a first target location of a set of target locations in the three-dimensional environment, wherein the set of target locations corresponds to a representation of the first user and the plurality of virtual objects other than the representation of the second user, the first electronic device receives, at 406, an indication of a change of pose of the second electronic device. For example, as shown in FIG. 3A, first electronic device 301a presents virtual representation 306b of second user 306a oriented toward shared virtual object 310 in environment 300a (e.g., shared virtual object 310 is a first target location of the set of target locations). In some examples, the set of target locations are associated with the communication session, and optionally correspond shared virtual objects and representations of participants of the communication session. In some examples, the indication is a wireless signal that is optionally received from the second electronic device and/or a companion device of the second electronic device (e.g., the companion device having one or more characteristics of electronic device 260 of FIG. 2B).

In some examples, at 408, in response to receiving the indication of the change of pose of the second electronic device, in accordance with a determination that the change of pose of the second electronic device includes rotation about a first axis that satisfies one or more first criteria, the first electronic device presents, at 410, via the one or more displays, the representation of the second user oriented toward a second target location, different from the first target location, of the set of target locations. For example, as shown in FIG. 3J, first electronic device 301a presents virtual representation 306b of second user 306a oriented toward first user 304a (e.g., and/or virtual representation 304b of first user 304a from the perspective of other participants of the communication session (e.g., within the shared virtual space of the communication session)) in response to receiving an indication of a change of pose of second electronic device 301b that includes rotation about a first axis (e.g., yaw rotation) that satisfies one or more first criteria for presenting virtual representation 306b oriented toward a different target location in environment 300a. In some examples, the one or more first criteria include one or more of the criteria described with reference to FIG. 3D.

In some examples, in response to receiving the indication of the change of pose of the second electronic device, in accordance with a determination that the change of pose of the second electronic device does not include rotation about the first axis that satisfies the one or more first criteria, the first electronic device maintains, at 412, presentation of the representation of the second user oriented toward the first target location of the set of target locations. For example, as shown in FIG. 3E, first electronic device 301a maintains presentation of virtual representation 306b oriented toward shared virtual object 310 in environment 300a in accordance with a determination that a change of pose of second electronic device 301b includes rotation about a second axis different from the first axis (e.g., pitch rotation instead of yaw rotation). For example, as shown in FIG. 3G, first electronic device 301a maintains presentation of virtual representation 306b oriented toward shared virtual object 310 in environment 300a in accordance with a determination that a change of pose of second electronic device 301b includes rotation about the first axis that does not satisfy the one or more first criteria (e.g., the change of pose of second electronic device 301b includes less than a threshold amount of yaw rotation). In accordance with the determination that the change of pose of the second electronic device does not include rotation about the first axis that satisfies the one or more first criteria, the first electronic device optionally changes a pose of a first portion of the representation of the second user while maintaining the representation of the second user oriented toward the first target location, such as first electronic device 301b presenting the change of pose of first portion 332 of virtual representation 306b relative to shared virtual object 310 in FIGS. 3E, 3F, and 3H.

It is understood that process 400 is an example and that more, fewer, or different operations can be performed in the same or in a different order. Additionally, the operations in process 400 described above are, optionally, implemented by running one or more functional modules in an information processing apparatus such as general-purpose processors (e.g., as described with respect to FIGS. 2A-2B) or application specific chips, and/or by other components of FIGS. 2A-2B.

Therefore, according to the above, some examples of the disclosure are directed to a method, comprising, at a first electronic device in communication with one or more displays and one or more input devices, while in a communication session with a second electronic device different from the first electronic device, wherein the first electronic device is associated with a first user and the second electronic device is associated with a second user: presenting, via the one or more displays, a plurality of virtual objects associated with the communication session in a three-dimensional environment, wherein the plurality of virtual objects includes a shared virtual object and a representation of the second user; and while presenting the representation of the second user oriented toward a first target location of a set of target locations in the three-dimensional environment, wherein the set of target locations corresponds to a representation of the first user and the plurality of virtual objects other than the representation of the second user, receiving an indication of a change of pose of the second electronic device. In some examples, the method further comprises, in response to receiving the indication of the change of pose of the second electronic device: in accordance with a determination that the change of pose of the second electronic device includes rotation about a first axis that satisfies one or more first criteria, presenting, via the one or more displays, the representation of the second user oriented toward a second target location, different from the first target location, of the set of target locations; and in accordance with a determination that the change of pose of the second electronic device does not include rotation about the first axis that satisfies the one or more first criteria, maintaining presentation of the representation of the second user oriented toward the first target location of the set of target locations.

Additionally, or alternatively, in some examples, while presenting the representation of the second user oriented toward the first target location, a first portion of the representation of the second user is presented with a first pose relative to the first target location. In some examples, the method further comprises, in response to receiving the indication of the change of pose of the second electronic device, in accordance with a determination that the change of pose of the second electronic device satisfies one or more second criteria, different from the one or more first criteria, maintaining presentation of the representation of the second user oriented toward the first target location and presenting the first portion of the representation of the second user with a second pose, different from the first pose, relative to the first target location.

Additionally, or alternatively, in some examples, the one or more second criteria include a criterion that is satisfied when the change of pose of the second electronic device includes rotation about a second axis, different from the first axis.

Additionally, or alternatively, in some examples, in response to receiving the indication of the change of pose of the second electronic device, in accordance with a determination that the change of pose of the second electronic device includes rotation about the first axis that does not satisfy the one or more first criteria, maintaining presentation of the representation of the second user oriented toward the first target location and maintaining presentation of the first portion of the representation of the second user with the first pose relative to the first target location.

Additionally, or alternatively, in some examples, the one or more second criteria include a criterion that is satisfied when the change of pose of the second electronic device includes rotation about the first axis that does not satisfy the one or more first criteria.

Additionally, or alternatively, in some examples, the one or more first criteria include a criterion that is satisfied when the rotation about the first axis exceeds a threshold amount of rotation about the first axis.

Additionally, or alternatively, in some examples, the one or more first criteria include a criterion that is satisfied when a forward vector from a perspective of the second user is closer to the second target location than others of the set of target locations associated with the communication session.

Additionally, or alternatively, in some examples, in accordance with the second target location corresponding to the shared virtual object, the one or more first criteria include a criterion that is satisfied when a forward vector from a perspective of the second user corresponds to the shared virtual object; and in accordance with the second target location corresponding to the representation of the first user, the one or more first criteria include a criterion that is satisfied when a forward vector from the perspective of the second user is within a threshold orientation from the representation of the first user.

Additionally, or alternatively, in some examples, the change of pose of the second electronic device includes a change of viewpoint from a first viewpoint to a second viewpoint, different from the first viewpoint, of the communication session from a perspective of the second user, the first viewpoint of the communication session from the perspective of the second user includes a forward vector corresponding to a first region of the communication session from the perspective of the second user, and the one or more first criteria include a criterion that is satisfied when the second viewpoint of the communication session from the perspective of the second user includes a forward vector corresponding to a second region, different from the first region, of the communication session from the perspective of the second user.

Additionally, or alternatively, in some examples, the second electronic device is included in a computing system including a third electronic device, different from the second electronic device. In some examples, the method further comprises, receiving an indication of interaction of the second user with the third electronic device; and in response to receiving the indication of interaction of the second user with the third electronic device, presenting, via the one or more displays, the representation of the second user with a visual indication corresponding to the interaction of the second user with the third electronic device.

Additionally, or alternatively, in some examples, the method further comprises, while presenting the representation of the second user in the three-dimensional environment, receiving an indication of participation of the second user in the communication session. In some examples, the method further comprises, in response to receiving the indication of the participation of the second user in the communication session: in accordance with a determination that the representation of the second user is oriented toward the first target location of the set of target locations in the three-dimensional environment, outputting, via an audio output device, the participation of the second user in a first manner; and in accordance with a determination that the representation of the second user is oriented toward the second target location of the set of target locations in the three-dimensional environment, outputting, via the audio output device, the participation of the second user in a second manner, different from the first manner.

Additionally, or alternatively, in some examples, the first target location corresponds to the representation of the first user and the second target location corresponds to a representation of a third user different from the first user and the second user. In some examples, the method further comprises, while presenting the representation of the second user in the three-dimensional environment, receiving an indication of participation of the second user in the communication session. In some examples, the method further comprises, in response to receiving the indication of the participation of the second user in the communication session: in accordance with a determination that the representation of the second user is oriented toward the first target location of the set of target locations, outputting, via the audio output device, the participation of the second user; and in accordance with a determination that the representation of the second user is oriented toward the second target location of the set of target locations, forgoing outputting the participation of the second user.

Additionally, or alternatively, in some examples, presenting the representation of the second user oriented toward the second target location includes presenting an animation corresponding to a transition from presenting the representation of the second user oriented toward the first target location to presenting the representation of the second user oriented toward the second target location.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a computing system, comprising: one or more processors; memory; and one or more programs stored in the memory and configured to executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method, comprising:
at a first electronic device in communication with one or more displays and one or more input devices:
while in a communication session with a second electronic device different from the first electronic device, wherein the first electronic device is associated with a first user and the second electronic device is associated with a second user:
presenting, via the one or more displays, a plurality of virtual objects associated with the communication session in a three-dimensional environment, wherein the plurality of virtual objects includes a shared virtual object and a representation of the second user;
while presenting the representation of the second user oriented toward a first target location of a set of target locations in the three-dimensional environment, wherein the set of target locations corresponds to a representation of the first user and the plurality of virtual objects other than the representation of the second user, receiving an indication of a change of pose of the second electronic device; and
in response to receiving the indication of the change of pose of the second electronic device:
in accordance with a determination that the change of pose of the second electronic device includes rotation about a first axis that satisfies one or more first criteria, presenting, via the one or more displays, the representation of the second user oriented toward a second target location, different from the first target location, of the set of target locations; and
in accordance with a determination that the change of pose of the second electronic device does not include rotation about the first axis that satisfies the one or more first criteria, maintaining presentation of the representation of the second user oriented toward the first target location of the set of target locations.

2. The method of claim 1, wherein while presenting the representation of the second user oriented toward the first target location, a first portion of the representation of the second user is presented with a first pose relative to the first target location, the method further comprising:
in response to receiving the indication of the change of pose of the second electronic device:
in accordance with a determination that the change of pose of the second electronic device satisfies one or more second criteria, different from the one or more first criteria, maintaining presentation of the representation of the second user oriented toward the first target location and presenting the first portion of the representation of the second user with a second pose, different from the first pose, relative to the first target location.

3. The method of claim 1, wherein the one or more first criteria include a criterion that is satisfied when the rotation about the first axis exceeds a threshold amount of rotation about the first axis.

4. The method of claim 1, wherein the one or more first criteria include a criterion that is satisfied when a forward vector from a perspective of the second user is closer to the second target location than others of the set of target locations associated with the communication session.

5. The method of claim 1, wherein:
in accordance with the second target location corresponding to the shared virtual object, the one or more first criteria include a criterion that is satisfied when a forward vector from a perspective of the second user corresponds to the shared virtual object; and
in accordance with the second target location corresponding to the representation of the first user, the one or more first criteria include a criterion that is satisfied when a forward vector from the perspective of the second user is within a threshold orientation from the representation of the first user.

6. The method of claim 1, wherein:
the change of pose of the second electronic device includes a change of viewpoint from a first viewpoint to a second viewpoint, different from the first viewpoint, of the communication session from a perspective of the second user;
the first viewpoint of the communication session from the perspective of the second user includes a forward vector corresponding to a first region of the communication session from the perspective of the second user; and
the one or more first criteria include a criterion that is satisfied when the second viewpoint of the communication session from the perspective of the second user includes a forward vector corresponding to a second region, different from the first region, of the communication session from the perspective of the second user.

7. The method of claim 1, further comprising:
while presenting the representation of the second user in the three-dimensional environment, receiving an indication of participation of the second user in the communication session; and
in response to receiving the indication of the participation of the second user in the communication session:
in accordance with a determination that the representation of the second user is oriented toward the first target location of the set of target locations in the three-dimensional environment, outputting, via an audio output device, the participation of the second user in a first manner; and
in accordance with a determination that the representation of the second user is oriented toward the second target location of the set of target locations in the three-dimensional environment, outputting, via the audio output device, the participation of the second user in a second manner, different from the first manner.

8. The method of claim 7, wherein the first target location corresponds to the representation of the first user and the second target location corresponds to a representation of a third user different from the first user and the second user, the method further comprising:
while presenting the representation of the second user in the three-dimensional environment, receiving an indication of participation of the second user in the communication session; and
in response to receiving the indication of the participation of the second user in the communication session:
in accordance with a determination that the representation of the second user is oriented toward the first target location of the set of target locations, outputting, via the audio output device, the participation of the second user; and
in accordance with a determination that the representation of the second user is oriented toward the second target location of the set of target locations, forgoing outputting the participation of the second user.

9. An electronic device, comprising:
one or more display devices;
one or more input devices;
one or more processors;
memory; and
one or more programs, wherein the one or more programs are stored in the memory and configured to be executed by the one or more processors, the one or more programs including instructions for performing:
while in a communication session with a second electronic device different from a first electronic device, wherein the first electronic device is associated with a first user and the second electronic device is associated with a second user:
presenting, via the one or more displays, a plurality of virtual objects associated with the communication session in a three-dimensional environment, wherein the plurality of virtual objects includes a shared virtual object and a representation of the second user;
while presenting the representation of the second user oriented toward a first target location of a set of target locations in the three-dimensional environment, wherein the set of target locations corresponds to a representation of the first user and the plurality of virtual objects other than the representation of the second user, receiving an indication of a change of pose of the second electronic device; and
in response to receiving the indication of the change of pose of the second electronic device:
in accordance with a determination that the change of pose of the second electronic device includes rotation about a first axis that satisfies one or more first criteria, presenting, via the one or more displays, the representation of the second user oriented toward a second target location, different from the first target location, of the set of target locations; and
in accordance with a determination that the change of pose of the second electronic device does not include rotation about the first axis that satisfies the one or more first criteria, maintaining presentation of the representation of the second user oriented toward the first target location of the set of target locations.

10. The electronic device of claim 9, wherein while presenting the representation of the second user oriented toward the first target location, a first portion of the representation of the second user is presented with a first pose relative to the first target location, the instructions further including instructions for performing:
in response to receiving the indication of the change of pose of the second electronic device:
in accordance with a determination that the change of pose of the second electronic device satisfies one or more second criteria, different from the one or more first criteria, maintaining presentation of the representation of the second user oriented toward the first target location and presenting the first portion of the representation of the second user with a second pose, different from the first pose, relative to the first target location.

11. The electronic device of claim 9, wherein the one or more first criteria include a criterion that is satisfied when the rotation about the first axis exceeds a threshold amount of rotation about the first axis.

12. The electronic device of claim 9, wherein the one or more first criteria include a criterion that is satisfied when a forward vector from a perspective of the second user is closer to the second target location than others of the set of target locations associated with the communication session.

13. The electronic device of claim 9, wherein:
in accordance with the second target location corresponding to the shared virtual object, the one or more first criteria include a criterion that is satisfied when a forward vector from a perspective of the second user corresponds to the shared virtual object; and
in accordance with the second target location corresponding to the representation of the first user, the one or more first criteria include a criterion that is satisfied when a forward vector from the perspective of the second user is within a threshold orientation from the representation of the first user.

14. The electronic device of claim 9, wherein:
the change of pose of the second electronic device includes a change of viewpoint from a first viewpoint to a second viewpoint, different from the first viewpoint, of the communication session from a perspective of the second user;
the first viewpoint of the communication session from the perspective of the second user includes a forward vector corresponding to a first region of the communication session from the perspective of the second user; and
the one or more first criteria include a criterion that is satisfied when the second viewpoint of the communication session from the perspective of the second user includes a forward vector corresponding to a second region, different from the first region, of the communication session from the perspective of the second user.

15. The electronic device of claim 9, the instructions further including:
while presenting the representation of the second user in the three-dimensional environment, receiving an indication of participation of the second user in the communication session; and
in response to receiving the indication of the participation of the second user in the communication session:
in accordance with a determination that the representation of the second user is oriented toward the first target location of the set of target locations in the three-dimensional environment, outputting, via an audio output device, the participation of the second user in a first manner; and
in accordance with a determination that the representation of the second user is oriented toward the second target location of the set of target locations in the three-dimensional environment, outputting, via the audio output device, the participation of the second user in a second manner, different from the first manner.

16. The electronic device of claim 15, wherein the first target location corresponds to the representation of the first user and the second target location corresponds to a representation of a third user different from the first user and the second user, the instructions further including instructions for performing:
while presenting the representation of the second user in the three-dimensional environment, receiving an indication of participation of the second user in the communication session; and
in response to receiving the indication of the participation of the second user in the communication session:
in accordance with a determination that the representation of the second user is oriented toward the first target location of the set of target locations, outputting, via the audio output device, the participation of the second user; and
in accordance with a determination that the representation of the second user is oriented toward the second target location of the set of target locations, forgoing outputting the participation of the second user.

17. A non-transitory computer-readable storage medium storing one or more programs, the one or more programs comprising instructions, which, when executed by an electronic device with one or more display devices and an input device, cause the electronic device to perform:
while in a communication session with a second electronic device different from a first electronic device, wherein the first electronic device is associated with a first user and the second electronic device is associated with a second user:
presenting, via the one or more displays, a plurality of virtual objects associated with the communication session in a three-dimensional environment, wherein the plurality of virtual objects includes a shared virtual object and a representation of the second user;
while presenting the representation of the second user oriented toward a first target location of a set of target locations in the three-dimensional environment, wherein the set of target locations corresponds to a representation of the first user and the plurality of virtual objects other than the representation of the second user, receiving an indication of a change of pose of the second electronic device; and
in response to receiving the indication of the change of pose of the second electronic device:
in accordance with a determination that the change of pose of the second electronic device includes rotation about a first axis that satisfies one or more first criteria, presenting, via the one or more displays, the representation of the second user oriented toward a second target location, different from the first target location, of the set of target locations; and
in accordance with a determination that the change of pose of the second electronic device does not include rotation about the first axis that satisfies the one or more first criteria, maintaining presentation of the representation of the second user oriented toward the first target location of the set of target locations.

18. The non-transitory computer-readable storage medium of claim 17, wherein while presenting the representation of the second user oriented toward the first target location, a first portion of the representation of the second user is presented with a first pose relative to the first target location, and the instructions further cause the electronic device to:
in response to receiving the indication of the change of pose of the second electronic device:
in accordance with a determination that the change of pose of the second electronic device satisfies one or more second criteria, different from the one or more first criteria, maintaining presentation of the representation of the second user oriented toward the first target location and presenting the first portion of the representation of the second user with a second pose, different from the first pose, relative to the first target location.

19. The non-transitory computer-readable storage medium of claim 17, wherein the one or more first criteria include a criterion that is satisfied when the rotation about the first axis exceeds a threshold amount of rotation about the first axis.

20. The non-transitory computer-readable storage medium of claim 17, wherein the one or more first criteria include a criterion that is satisfied when a forward vector from a perspective of the second user is closer to the second target location than others of the set of target locations associated with the communication session.

21. The non-transitory computer-readable storage medium of claim 17, wherein:
in accordance with the second target location corresponding to the shared virtual object, the one or more first criteria include a criterion that is satisfied when a forward vector from a perspective of the second user corresponds to the shared virtual object; and
in accordance with the second target location corresponding to the representation of the first user, the one or more first criteria include a criterion that is satisfied when a forward vector from the perspective of the second user is within a threshold orientation from the representation of the first user.

22. The non-transitory computer-readable storage medium of claim 17, wherein:
the change of pose of the second electronic device includes a change of viewpoint from a first viewpoint to a second viewpoint, different from the first viewpoint, of the communication session from a perspective of the second user;
the first viewpoint of the communication session from the perspective of the second user includes a forward vector corresponding to a first region of the communication session from the perspective of the second user; and
the one or more first criteria include a criterion that is satisfied when the second viewpoint of the communication session from the perspective of the second user includes a forward vector corresponding to a second region, different from the first region, of the communication session from the perspective of the second user.

23. The non-transitory computer-readable storage medium of claim 17, the instructions causing the electronic device to further perform:
while presenting the representation of the second user in the three-dimensional environment, receiving an indication of participation of the second user in the communication session; and
in response to receiving the indication of the participation of the second user in the communication session:
in accordance with a determination that the representation of the second user is oriented toward the first target location of the set of target locations in the three-dimensional environment, outputting, via an audio output device, the participation of the second user in a first manner; and
in accordance with a determination that the representation of the second user is oriented toward the second target location of the set of target locations in the three-dimensional environment, outputting, via the audio output device, the participation of the second user in a second manner, different from the first manner.

24. The non-transitory computer-readable storage medium of claim 23, wherein the first target location corresponds to the representation of the first user and the second target location corresponds to a representation of a third user different from the first user and the second user, and the instructions further cause the electronic device to:
while presenting the representation of the second user in the three-dimensional environment, receiving an indication of participation of the second user in the communication session; and
in response to receiving the indication of the participation of the second user in the communication session:
in accordance with a determination that the representation of the second user is oriented toward the first target location of the set of target locations, outputting, via the audio output device, the participation of the second user; and
in accordance with a determination that the representation of the second user is oriented toward the second target location of the set of target locations, forgoing outputting the participation of the second user.
